(19) United States
(12) Patent Application Publication
(10) Pub. No.: US 2008/0199246 A1
(43) Pub. Date: Aug. 21, 2008

(54) Ring Binder Mechanism having Plastic Housing

(75) Inventors: Chun Yuen To, Hong Kong (CN); Hung Yu Cheng, Hong Kong (CN); Ming Hah Wong, HuBei Province (CN)

Correspondence Address: SENNIGER POWERS LLP, ONE METROPOLITAN SQUARE, 16TH FLOOR, ST LOUIS, MO, 63102, US

(73) Assignee: WORLD WIDE STATIONERY MFG. CO., LTD., Hong Kong (CN)

(21) Appl. No.: 11/675,487

(22) Filed: Feb. 15, 2007

(51) Int. Cl. B42F 3/04

(52) U.S. Cl. 402/20; 402/31

(57) ABSTRACT

A ring binder mechanism for retaining loose-leaf pages has a housing, hinge plates, and ring members mounted on the hinge plates for retaining pages on the mechanism. The housing includes a plastic upper housing element and a lower housing element underlying the upper housing element. The lower housing element may be a single piece or multiple pieces. An actuating lever may be pivotally mounted on the housing for engaging the hinge plates and pivoting them to selectively move the ring members between an open position and a closed position.

### FIELD OF THE INVENTION

This invention relates to a ring binder mechanism for retaining loose-leaf pages, and in particular to a ring binder mechanism having a housing constructed in part from plastic.

### BACKGROUND OF THE INVENTION

A ring binder mechanism retains loose-leaf pages, such as hole-punched pages, in a file or notebook. It has ring members for retaining the pages. The ring members may be selectively opened to add or remove pages or closed to retain pages while allowing the pages to be moved along the ring members. The ring members mount on two adjacent hinge plates that join together about a pivot axis.

A housing—typically metal and elongated—loosely supports the hinge plates within the housing and holds the hinge plates together so they may pivot relative to the housing. The housing has a generally C-shaped cross-section, with bent-under rims that hold the hinge plates within the housing. The hinge plates are disposed within and extend across the open part of the cross-sectional “C,” spaced from the back wall of the “C,” and the ring members extend through notches or openings in the housing.

The undeformed housing is slightly narrower than the joined hinge plates when the hinge plates are in a coplanar position (180°). So as the hinge plates pivot through this position, they deform the resilient housing and cause a spring force in the housing that urges the hinge plates to pivot away from the coplanar position, either opening or closing the ring members. Thus, when the ring members are closed the spring force resists hinge plate movement and clamps the ring members together. Similarly, when the ring members are open, the spring force holds them apart. An operator may typically overcome this force by manually pulling the ring members apart or pushing them together. Levers may also be provided on one or both ends of the housing for moving the ring members between the open and closed positions.

Conventionally, the housing is mounted to the file or notebook with the open part of the housing cross-sectional “C” facing the file or notebook. Thus, the hinge plates are covered by the back wall of the cross-sectional “C.” This configuration presents a generally solid metal surface (the exterior surface of the back wall of the cross-sectional “C”) as the exposed surface of the housing.

This exposed surface often has a nickel-containing coating, to which some people may be sensitive. Additionally, it is difficult and/or more costly to print on a metal surface—particularly where the metal surface is nickel-coated—in a manner that the printing is retained on the surface.

### SUMMARY OF THE INVENTION

In one embodiment, a ring binder mechanism for holding loose-leaf pages generally comprises an elongate housing including an upper, plastic housing element and a lower housing element underlying the upper housing element. A ring support is disposed between the upper and lower housing elements and supported by the housing for movement relative to the housing. Rings for holding the loose-leaf pages are supported by the ring support. In particular, each ring includes a first ring member and a second ring member, with the first ring member being mounted on the ring support for movement relative to the second ring member between a closed position and an opened position. In the closed position the two ring members form a substantially continuous, closed loop for allowing loose-leaf pages retained by the rings to be moved along the rings from one ring member to the other, and in the opened position the two ring members form a discontinuous, open loop for adding or removing loose-leaf pages from the rings.

Provision of a plastic upper housing element facilitates color-coding notebooks or files in which the ring binder mechanism is incorporated, and it facilitates printing on the housing, e.g., with raised or imprinted lettering or with inks that adhere more easily and less expensively to plastic than to metal. Furthermore, a plastic upper housing element reduces exposure to potentially allergenic nickel plating.

Other features will be in part apparent and in part pointed out hereinafter.

### BRIEF DESCRIPTION OF THE DRAWINGS

FIG. 1 is a perspective view of a notebook incorporating a first embodiment of a ring binder mechanism;

FIG. 2 is an exploded perspective view of the ring binder mechanism shown in FIG. 1;

FIG. 3 is a perspective view of the ring binder mechanism shown in FIG. 1, partially disassembled;

FIG. 4 is a perspective view of the ring binder mechanism shown in FIG. 1 in an open configuration;

FIG. 5 is a longitudinal section view of the ring binder mechanism shown in FIG. 1, with the mechanism, in a closed configuration;

FIG. 6 is a fragmentary lateral section view of the ring binder mechanism shown in FIG. 1, with the mechanism in its closed configuration, and with portions removed to reveal internal construction;

FIG. 7 is a fragmentary lateral section view similar to FIG. 6, with the mechanism show in its open configuration;

FIG. 8 is an exploded perspective view of a second embodiment of a ring binder mechanism;

FIG. 9 is a longitudinal section view of the ring binder mechanism shown in FIG. 8, with the mechanism in a closed configuration;

FIG. 10 is an exploded perspective view of a third embodiment of a ring binder mechanism;

FIG. 11 is a longitudinal section view of the ring binder mechanism shown in FIG. 10, with the mechanism in a closed configuration;

FIG. 12 is an exploded perspective view of a fourth embodiment of a ring binder mechanism;

FIG. 13 is a longitudinal section view of the ring binder mechanism shown in FIG. 12, with the mechanism in a closed configuration;

FIG. 14 is an exploded perspective view of a fifth embodiment of a ring binder mechanism;

FIG. 15 is a longitudinal section view of the ring binder mechanism shown in FIG. 14, with the mechanism in a closed configuration;

FIG. 16 is an exploded perspective view of a sixth embodiment of a ring binder mechanism;

FIG. 17 is a perspective view of the ring binder mechanism shown in FIG. 16, partially disassembled;

FIG. 18 is an exploded perspective view of a seventh embodiment of a ring binder mechanism;

FIG. 19 is a perspective view of the ring binder mechanism shown in FIG. 18, partially disassembled;

FIG. 20 is a perspective view of the ring binder mechanism shown in FIG. 18 in a closed configuration;

FIG. 21 is a perspective view of the ring binder mechanism shown in FIG. 18 in an open configuration;

FIG. 22 is an exploded perspective view of an eighth embodiment of a ring binder mechanism;

FIG. 23 is a perspective view of the ring binder mechanism shown in FIG. 22, partially disassembled;

FIG. 24 is a fragmentary lateral section view of the ring binder mechanism shown in FIG. 22, with the mechanism in a closed configuration;

FIG. 25 is a longitudinal section view of the ring binder mechanism shown in FIG. 22, with the mechanism in the closed configuration;

FIG. 26 is a fragmentary lateral section view of the ring binder mechanism shown in FIG. 22, with the mechanism in an open configuration;

FIG. 27 is a longitudinal section view of the ring binder mechanism shown in FIG. 22, with the mechanism in the open configuration;

FIG. 28 is an exploded perspective view of a ninth embodiment of a ring binder mechanism;

FIG. 29 is a perspective view of the ring binder mechanism shown in FIG. 28, partially disassembled;

FIG. 30 is a fragmentary lateral section view of the ring binder mechanism shown in FIG. 28, with the mechanism in a closed configuration;

FIG. 31 is a fragmentary lateral section view similar to FIG. 30, with the mechanism in an open configuration;

FIG. 32 is an exploded perspective view of a tenth embodiment of a ring binder mechanism;

FIG. 33 is a perspective view of the ring binder mechanism shown in FIG. 32, partially disassembled;

FIG. 34 is a perspective view of the ring binder mechanism shown in FIG. 32, with the mechanism in a closed configuration;

FIG. 35 is a fragmentary lateral section view of the ring binder mechanism shown in FIG. 32, with the mechanism in the closed configuration;

FIG. 36 is a longitudinal section view of the ring binder mechanism shown in FIG. 32, with the mechanism in the closed configuration;

FIG. 37 is a fragmentary lateral section view of the ring binder mechanism shown in FIG. 32, with the mechanism in an open configuration;

FIG. 38 is a longitudinal section view of the ring binder mechanism shown in FIG. 32, with the mechanism in the open configuration;

FIG. 39 is a perspective view of the ring binder mechanism shown in FIG. 32, with the mechanism in the opened configuration;

FIG. 40 is an exploded perspective view of an eleventh embodiment of a ring binder mechanism;

FIG. 41 is a perspective view of the ring binder mechanism shown in FIG. 40, with the mechanism in a closed configuration;

FIG. 42 is an exploded perspective view of a twelfth embodiment of a ring binder mechanism;

FIG. 43 is a perspective view of the ring binder mechanism shown in FIG. 42, with a portion of the upper housing element broken away;

FIG. 44 is a bottom perspective view of the ring binder mechanism shown in FIG. 42;

FIG. 45 is an exploded perspective view of a thirteenth embodiment of a ring binder mechanism;

FIG. 46 is a perspective view of the ring binder mechanism shown in FIG. 45, partially disassembled;

FIG. 47 is a fragmentary lateral section view of the ring binder mechanism shown in FIG. 45, with the mechanism in a closed configuration;

FIG. 48 is a longitudinal section view of the ring binder mechanism shown in FIG. 45, with the mechanism in the closed configuration;

FIG. 49 is a fragmentary lateral section view of the ring binder mechanism shown in FIG. 45, with the mechanism in an open configuration;

FIG. 50 is a longitudinal section view of the ring binder mechanism shown in FIG. 45, with the mechanism in the open configuration;

FIG. 51 is an exploded perspective view of a fourteenth embodiment of a ring binder mechanism;

FIG. 52 is a perspective view of the ring binder mechanism shown in FIG. 51, partially disassembled;

FIG. 53 is a perspective view of the ring binder mechanism shown in FIG. 51, with the mechanism in a closed configuration;

FIG. 54 is a bottom perspective view of the ring binder mechanism shown in FIG. 51, with the mechanism in the closed configuration;

FIG. 55 is a fragmentary lateral section view of the ring binder mechanism shown in FIG. 51, with the mechanism in the closed configuration;

FIG. 56 is a longitudinal section view of the ring binder mechanism shown in FIG. 51, with the mechanism in the closed configuration;

FIG. 57 is a fragmentary lateral section view of the ring binder mechanism shown in FIG. 51, with the mechanism in an open configuration;

FIG. 58 is a longitudinal section view of the ring binder mechanism shown in FIG. 51, with the mechanism in the open configuration;

FIG. 59 is a perspective view of the ring binder mechanism shown in FIG. 51, with the mechanism in the open configuration;

FIG. 60 is a perspective view of a notebook incorporating a fifteenth embodiment of a ring binder mechanism;

FIG. 61 is an exploded perspective view of the ring binder mechanism shown in FIG. 60;

FIG. 62 is a perspective view of the ring binder mechanism shown in FIG. 60, partially disassembled;

FIG. 63 is a bottom perspective view of the ring binder mechanism shown in FIG. 60, with the mechanism in a closed configuration;

FIG. 64 is a longitudinal section view of the ring binder mechanism shown in FIG. 60;

FIG. 65 is a bottom perspective view of the ring binder mechanism shown in FIG. 60, with the mechanism in an open configuration;

FIG. 66 is an exploded perspective view of a sixteenth embodiment of a ring binder mechanism;

FIG. 67 is a perspective view of the ring binder mechanism shown in FIG. 66, partially disassembled;

FIG. 68 is an exploded perspective view of a seventeenth embodiment of a ring binder mechanism;

FIG. 69 is a perspective view of the ring binder mechanism shown in FIG. 68, partially disassembled;

FIG. 70 is an exploded perspective view of an eighteenth embodiment of a ring binder mechanism;

FIG. 71 is a perspective view of the ring binder mechanism shown in FIG. 70, partially disassembled;

FIG. 72 is a bottom view of a nineteenth embodiment of a ring binder mechanism;

FIG. 73 is a side view of the ring binder mechanism shown in FIG. 72;

FIG. 74 is a top view of the ring binder mechanism shown in FIG. 72;

FIG. 75 is a bottom view of a twentieth embodiment of a ring binder mechanism;

FIG. 76 is a side view of the ring binder mechanism shown in FIG. 75; and

FIG. 77 is a top view of the ring binder mechanism shown in FIG. 75.

Corresponding reference numbers indicate corresponding parts throughout the views of the drawings.

### DETAILED DESCRIPTION

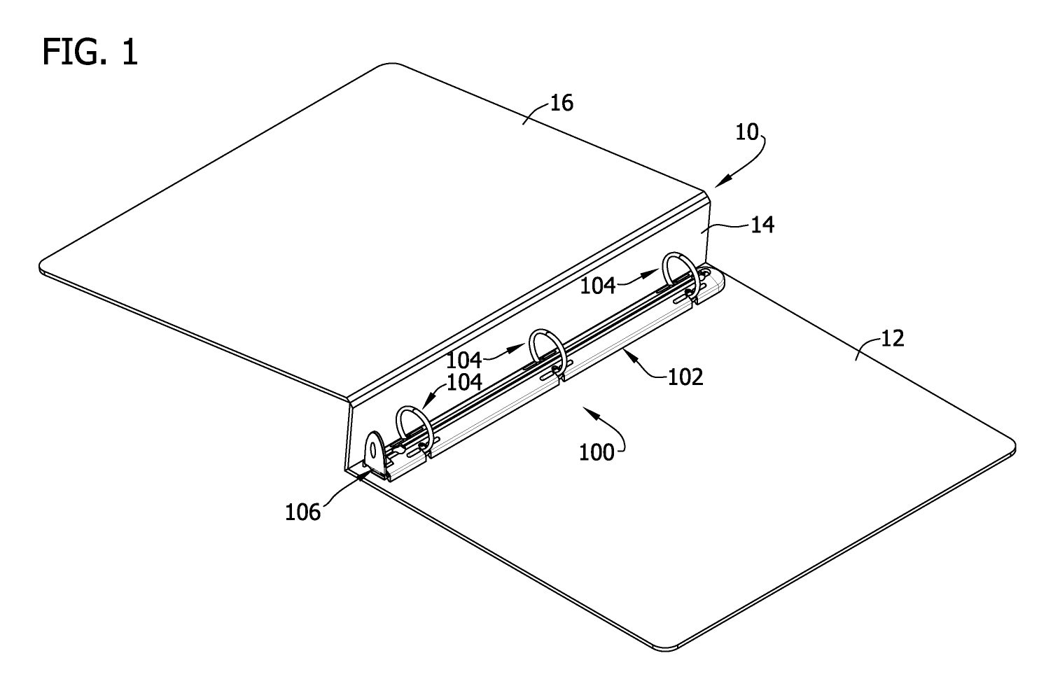

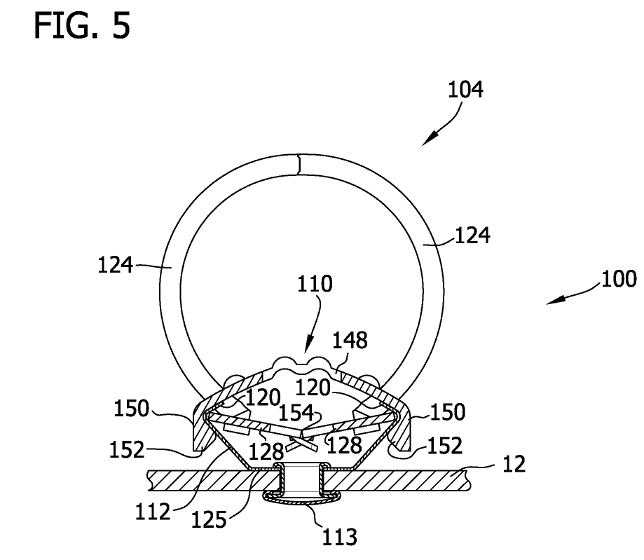

Referring to the drawings, FIGS. 1-7 illustrate a first embodiment of a ring binder mechanism, generally indicated at 100. In FIG. 1, the mechanism 100 is shown mounted on a notebook designated generally at 10. Specifically, the mechanism 100 is shown mounted on the back cover 12 of the notebook 10 by means of rivets 113 (FIG. 5), generally adjacent to and aligned with the spine 14 of the notebook 10. The front cover 16 of the notebook 10 is hingedly connected to the spine 14 and moves to selectively cover or expose loose-leaf pages (not shown) retained by the mechanism 100 in the notebook 10. Ring binder mechanisms mounted on notebooks in other ways (e.g., on the spine) or on surfaces other than a notebook (e.g., a file) do not depart from the scope of this invention.

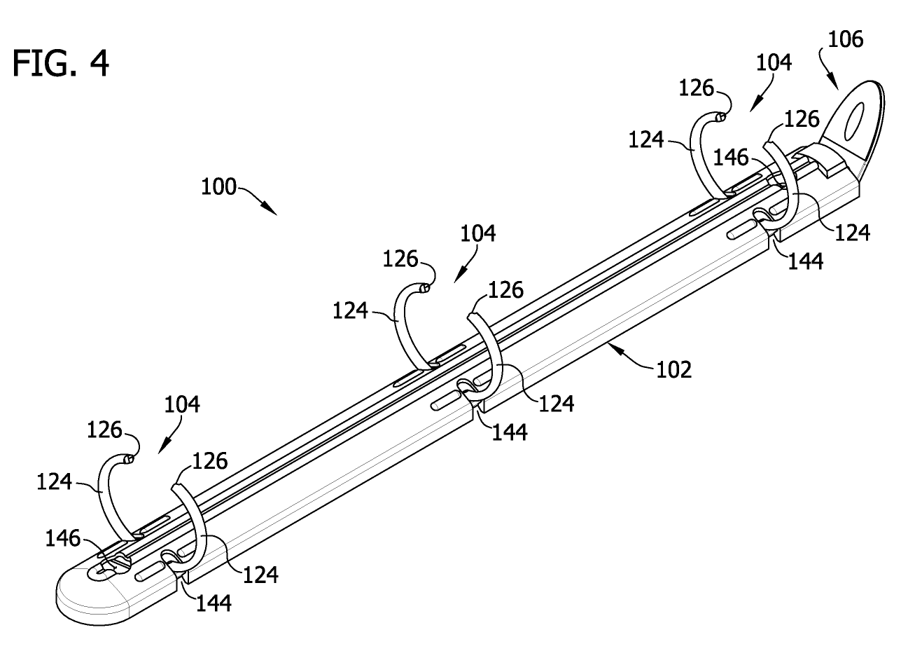

As shown in FIGS. 1 and 4, a housing, designated generally at 102, supports three rings (each designated generally at 104) and a lever (broadly, an “actuator,” and designated generally at 106). The rings 104 retain loose-leaf pages on the ring binder mechanism 100 in the notebook 10 while the lever 106 operates to open and close the rings 104 so that pages may be added or removed.

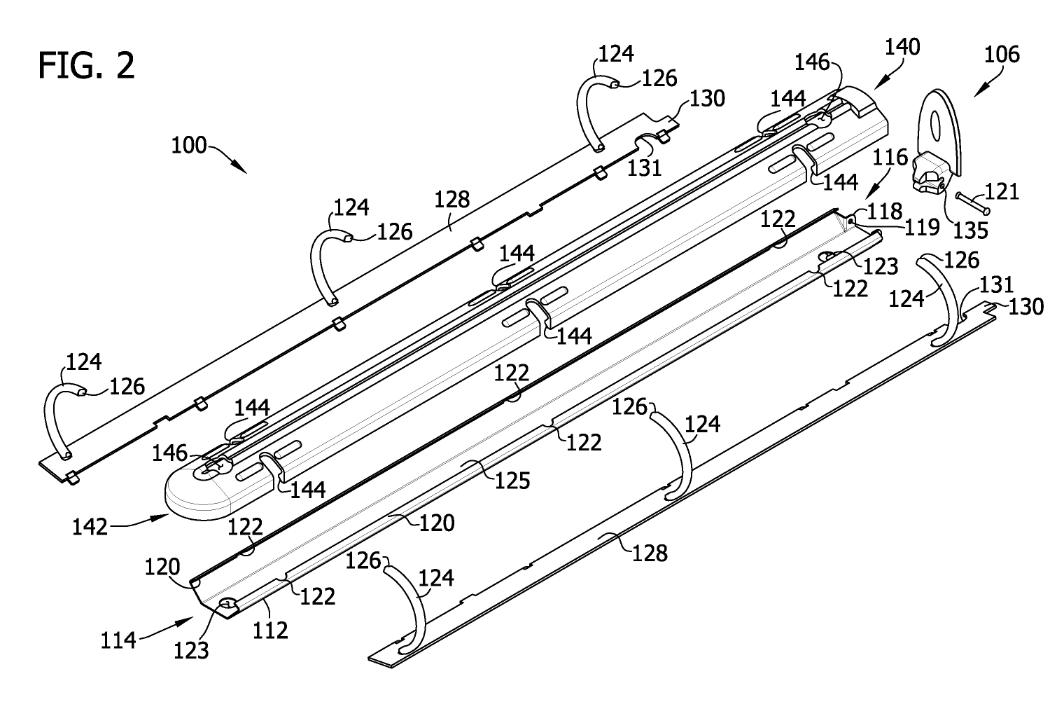

As best shown in FIGS. 2, 3, and 5, the housing 102 includes an upper housing element 110 and a lower housing element 112 underlying the upper housing element 110. The upper housing element 110 is suitably constructed of a plastic material. Examples of suitable plastic materials include, without limitation polypropylene and polycarbonate. The lower housing element 112 is made from metal so as to provide a suitable spring force to the housing, as explained in greater detail below.

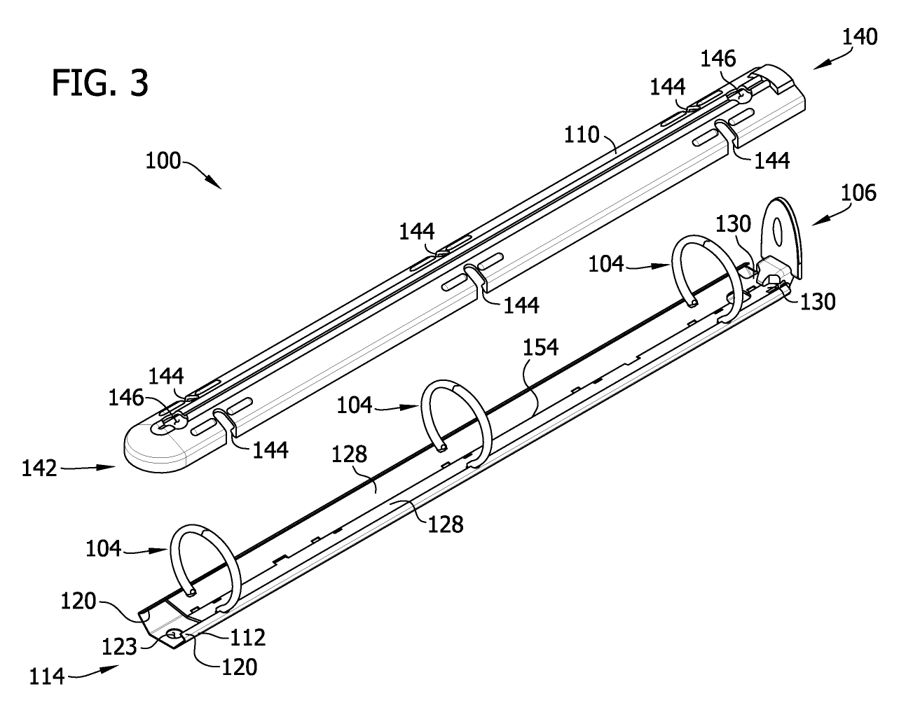

In the first embodiment 100, the lower housing element 112 is shaped as an elongated rectangle with a uniform, roughly C-shaped cross section. A first longitudinal end 114 of the lower housing element 112 is generally open, and a second, opposite longitudinal end 116, while also generally open, has inwardly spaced, upstanding lever-mounting wall elements 118. Bent-in rims, each designated at 120 (FIGS. 2, 3, and 5), extend lengthwise along longitudinal edges of the lower housing element 112 from the first longitudinal end 114 to the second longitudinal end 116. Notches 122 are formed in the bent-in rims to accommodate the rings 104 of the binder mechanism 100, as best shown in FIG. 3. Attachment holes 123 are formed through the base portion 125 of the lower housing element 112, near both of the longitudinal ends, to receive the rivets 113 or other means by which the housing 102 is secured to the notebook 10.

The three rings 104 of the ring binder mechanism 100 are substantially similar and are each generally circular in shape. As shown in FIGS. 2, 4, and 5, the rings 104 each include two generally semi-circular ring members 124 formed from a conventional, cylindrical rod of a suitable material (e.g., steel). The ring members 124 include free ends 126 formed to secure the ring members 124 against transverse misalignment when they are closed together. The rings 104 could be D-shaped as is known in the art, or shaped otherwise within the scope of this invention. Ring binder mechanisms with ring members formed of different material or having different cross-sectional shapes, for example, oval shapes, do not depart from the scope of this invention.

As also shown in FIGS. 2, 3, and 5, the first embodiment 100 of a ring binder mechanism includes two generally identical—but substantially mirror-image of each other—hinge plates 128 (broadly, a “ring support”) supporting the ring members 124. The hinge plates 128 of the first embodiment 100 are each generally elongate, flat, and rectangular in shape, and are each somewhat shorter in length than the lower housing element 112 as shown in FIG. 3. A finger 130 extends longitudinally away from a first end of each of the hinge plates 128 (to the right in FIGS. 2 and 3). The fingers 130 are each narrower in width than the main body portion of their respective hinge plate 128 and are positioned with their inner longitudinal edges generally aligned with the inner longitudinal edges of the main body portions of the hinge plates 128. Cutouts 131 are formed in the inner longitudinal edges of the hinge plates 128, near the ends from which the fingers 130 extend, to provide access to the attachment hole 123 near that end of the housing. The hinge plates 128 are short enough that the attachment hole 123 near the opposite end of the housing remains accessible, as best shown in FIG. 3. It is contemplated and understood that a moveable ring support other than hinge plates may be used in this and any of the other embodiments set forth herein without departing from the scope of this invention.

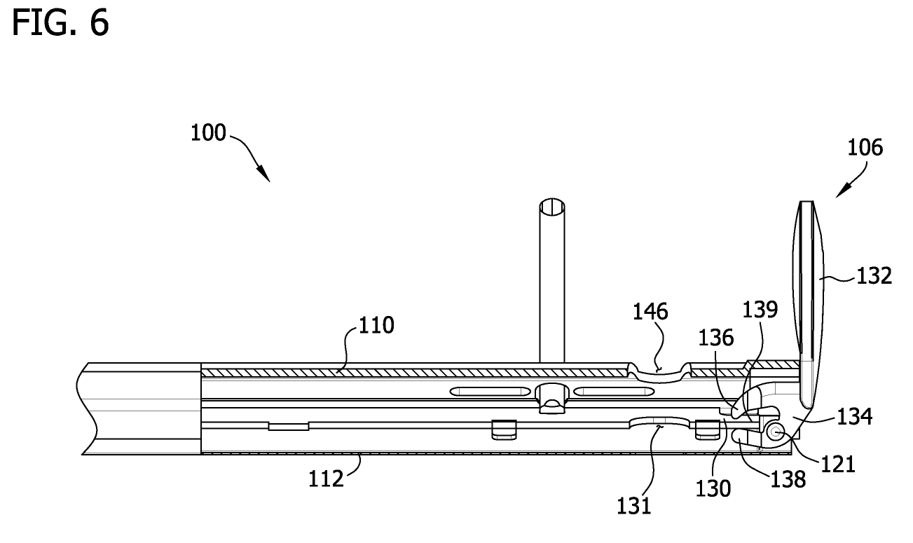

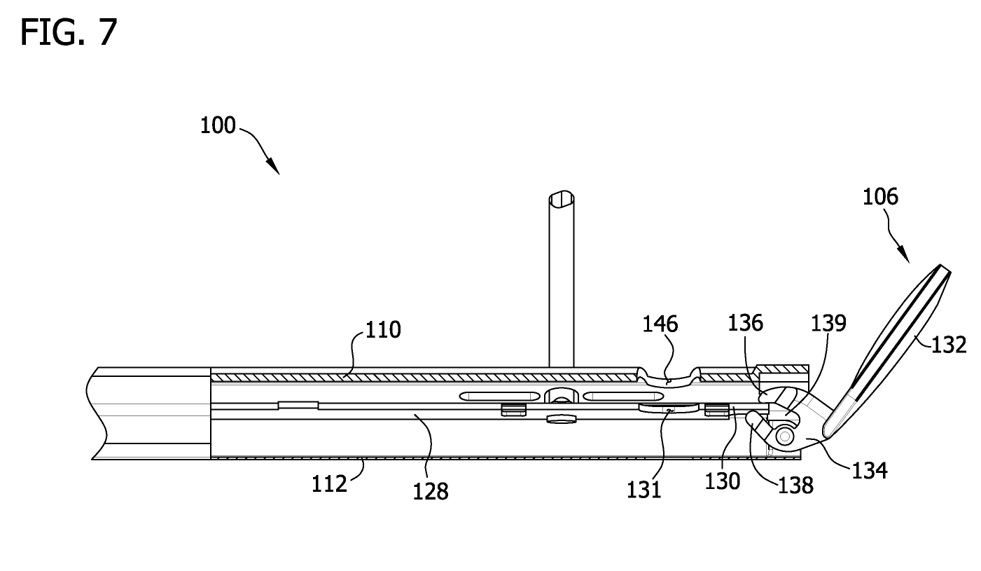

As best shown in FIGS. 6 and 7, the lever 106 includes a grip 132, a body 134 attached to the grip 132, and an upper lip 136 and lower lip 138 extending from the body 134. The grip 132 is somewhat broader than each of the body 134, upper lip 136, and lower lip 138 and facilitates grasping the lever 106 and applying force to move the lever 106. In the illustrated ring binder mechanism 100, the body 134 is formed as one piece with the grip 132 for substantially conjoint movement with the grip 132.

As noted above, the upper housing element 110 is suitably made from plastic. This allows the upper housing element to be fabricated in a variety of different colors, which is useful for color-coding notebooks. Additionally, printed text (either raised or imprinted) may be molded into or otherwise formed in the upper housing element 110 if so desired.

In the first embodiment 100, the upper housing element 110 is generally rectangular and elongated, and is approximately the same length as the lower housing element 112. A first longitudinal end 140 of the upper housing element is generally open to accommodate the lever 106, while a second, opposite longitudinal end 142 of the upper housing element may be closed. Slots 144 are formed in the lateral sides of the upper housing element 110 to accommodate the rings 104, as best shown in FIG. 4, and access holes 146 are formed in the upper, midline portion of the upper housing element to provide access to the rivets 113 or other means by which the housing 102 is secured to the notebook 10.

As best shown in FIG. 5, the upper housing element 110 has a generally concave cross-sectional configuration, with a central portion 148 and lateral sides 150 extending downwardly along either side of the central portion 148. The lateral sides 150 are spaced apart by a distance that is essentially the same as the width of the lower housing element 112, but ridges 152 protrude slightly inwardly. This configuration allows the upper housing element 110 to be snap-fit connected to the lower housing element 112.

The ring binder mechanism 100 in assembled form will now be described. As illustrated in FIGS. 3, 6, and 7, the lever 106 is mounted to the second longitudinal end 116 of the lower housing element 112. In particular, the body 134 of the lever 106 is positioned between the lever-mounting wall elements 118, with passage 135 extending through the body 134 (FIG. 2) aligned with holes 119 in the wall elements 118. Pivot pin 121 passes through the passage 135 and holes 119 to pivotally mount the lever 106 to the lower housing element 112.

As shown in FIGS. 3 and 5, the hinge plates 128 are interconnected in parallel arrangement along their inner longitudinal edge margins, forming a central hinge 154 having a pivot axis. This is done in a conventional manner known in the art. As will be described, the hinge plates 128 can pivot about the hinge 154 upward and downward. The lower housing element 112 supports the interconnected hinge plates 128 within it. The outer longitudinal edge margins of the hinge plates 128 loosely fit behind the bent-in rims 120 of the lower housing element 112 for allowing them to move within the rims when the hinge plates 128 pivot. As shown in FIGS. 3, 6, and 7, the fingers 130 of the hinge plates 128 extend into the space 139 between the upper lip 136 and the lower lip 138 of the lever 106 so that lower surfaces of the hinge plate fingers 130 are engageable by the lower lip 138 and upper surfaces of the hinge plate fingers 130 are engageable by the upper lip 136.

The ring members 124 are each mounted on upper surfaces of respective ones of the hinge plates 128 in generally opposed fashion with their free ends 126 facing, and they are accommodated in the notches 122 formed in the bent-in rims 120. The upper housing element 110 is snap-fit connected to the lower housing element 112 so as to cover the hinge plates 128 and enclose the housing 102, and the ring members 124 extend through respective slots 144 along the sides of the upper housing element 110 so that the free ends 126 of the ring members can engage above the housing 102. In the first embodiment 100, the ring members 124 are rigidly connected to the hinge plates 128 as is known in the art and move with the hinge plates when they pivot. Although in the illustrated ring binder mechanism 100 both ring members 124 of each ring 104 are each mounted on one of the two hinge plates 128 and move with the pivoting movement of the hinge plates 128, a mechanism in which each ring has one movable ring member and one fixed ring member does not depart from the scope of this invention (e.g., a mechanism in which only one of the ring members of each ring is mounted on a hinge plate with the other ring member mounted, for example, on a housing).

Operation of the ring binder mechanism 100 will now be described. As is known, the hinge plates 128 pivot upward and downward relative to the lower housing element 112, about the central hinge 154, and move the ring members 124 mounted thereon between a closed position (e.g., FIGS. 1, 3, 5, and 6) and an open position (e.g., FIGS. 4 and 7). The hinge plates 128 are wider than the lower housing element 112 when in a co-planar position (180°), so as they pivot through the co-planar position, they deform the lower housing element 112 which creates a small spring force in the lower housing element 112. The housing spring force biases the hinge plates 128 to pivot away from the co-planar position, either downward or upward. The ring members 124 close when the hinge plates 128 pivot downward (i.e., the hinge 154 moves toward the lower housing element 112 as shown in FIG. 5); the ring members 124 open when the hinge plates 128 pivot upward (i.e., the hinge 154 moves away from the lower housing element 112.

In FIGS. 3, 5, and 6, the ring binder mechanism 100 is in a closed configuration. The hinge plates 128 are pivoted downward, toward the lower housing element 112, so that the ring members 124 of each ring 104 are together in a continuous, circular loop, capable of retaining loose-leaf pages. The lever 106 is vertical relative to the housing 102, with the upper surface of the lower lip 138 of the lever engaging the lower surfaces of the hinge plate fingers 130.

To unlock the ring binder mechanism 100 and open the ring members 104, an operator applies force to the grip 132 of the lever 106 and pivots it outwardly (i.e., to the right, as shown in FIGS. 6 and 7). This causes the upper surface of the lower lip 138 of the lever to press upward against the lower surfaces of the hinge plate fingers 130 and pushes the central hinge 154 upwardly. Given sufficient force applied to the grip 132, the spring force of the lower housing element 112 will be overcome, and the hinge plates 128 will pivot upwardly through their co-planar position into the open configuration, which opens the ring members 124 as best shown in FIG. 4. (Depending on the specific geometry of the hinge plates 128 and the hinge plate fingers 130, the hinge plate fingers 130 may flex slightly relative to the main body portions of the hinge plates 128 before the hinge plates 128 pivot upwardly through their co-planar position.) Conversely, to close the ring binder mechanism 100 and close the ring members 104, an operator applies force to the grip 132 of the lever 106 and pivots it inwardly (i.e., to the left, as shown in FIGS. 6 and 7). This causes the lower surface of the upper lip 136 of the lever to press downward against the upper surfaces of the hinge plate fingers 130 and pushes the central hinge 154 downwardly. Given sufficient force applied to the grip 132, the spring force of the lower housing element 112 will be overcome, and the hinge plates 128 will pivot downwardly through their co-planar position into the closed configuration (FIGS. 3 and 5), which closes the ring members 124. In the illustrated mechanism 100, the ring members 124 can also be opened and closed by manually pulling and pushing the free ends 126 of the ring members 124 apart and together, respectively.

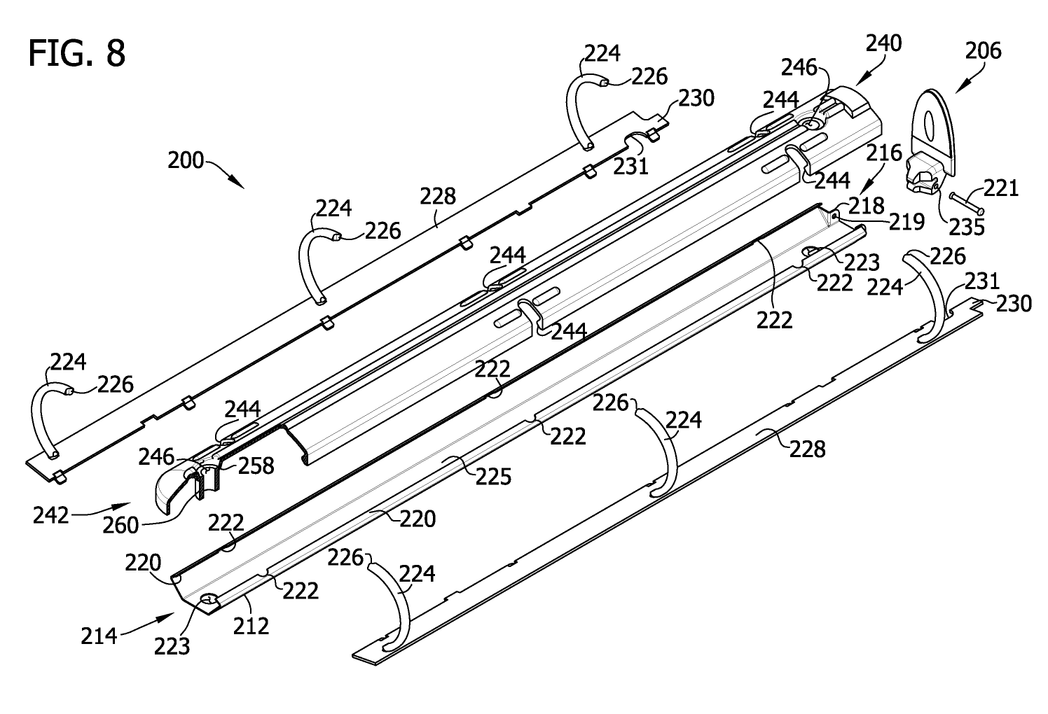

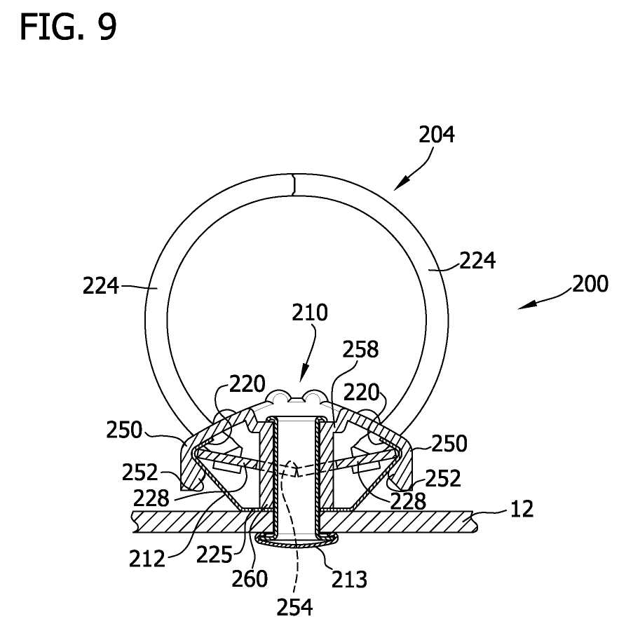

A second embodiment 200 of a ring binder mechanism with a plastic upper housing element 210 is illustrated in FIGS. 8 and 9. The second embodiment 200 is substantially identical to the first embodiment 100, and corresponding components are labeled with reference numbers that have been incremented by 100, i.e., that are in the 200's. Operation of the two embodiments 100 and 200 is identical.

The only difference between the first and second embodiments is that in the second embodiment 200, the material surrounding the access hole 246 at each end of the plastic upper housing element 210 is thickened for reinforcement as at 258, and a support post 260 surrounds and extends downwardly from the thickened portion around each access hole 246. By using a longer rivet 213 which engages the upper surface of the thickened portion and the bottom surface of the structure to which the ring binder mechanism is attached (e.g., the back cover 12 of a notebook 10) and clamps the support post 260 therebetween, the ring binder mechanism 200 can be secured to the structure in a manner that prevents the upper housing element 210 from being removed from the lower housing element 212. (Compare FIG. 9 to FIG. 5; in the first embodiment 100, the upper housing element 110 can be removed from the lower housing element 112.)

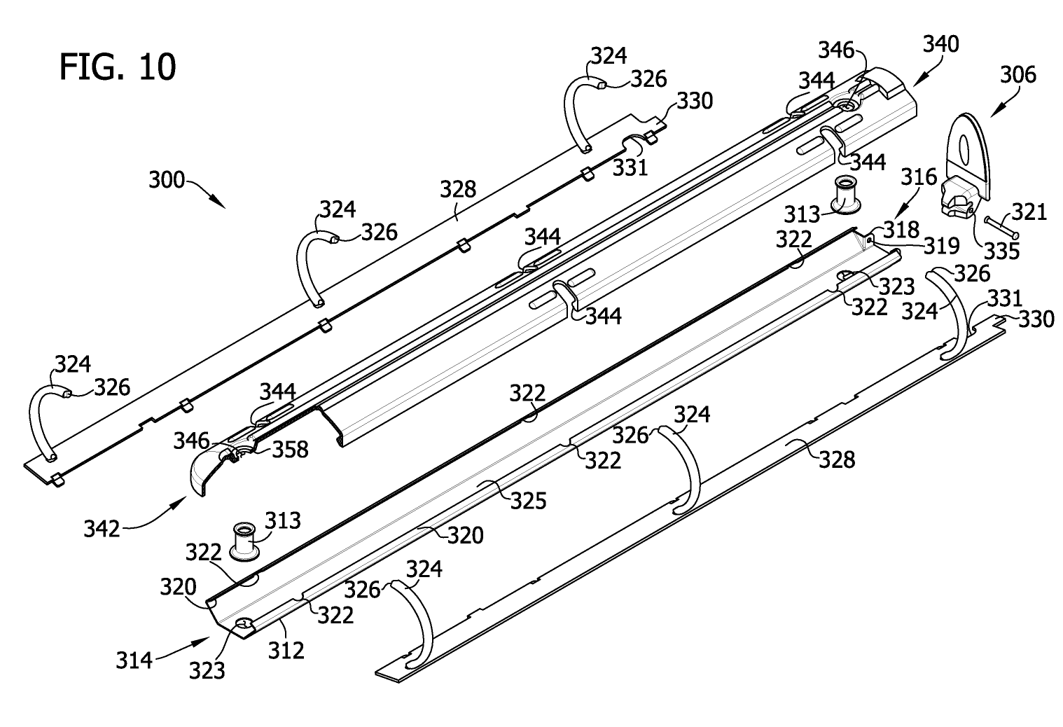

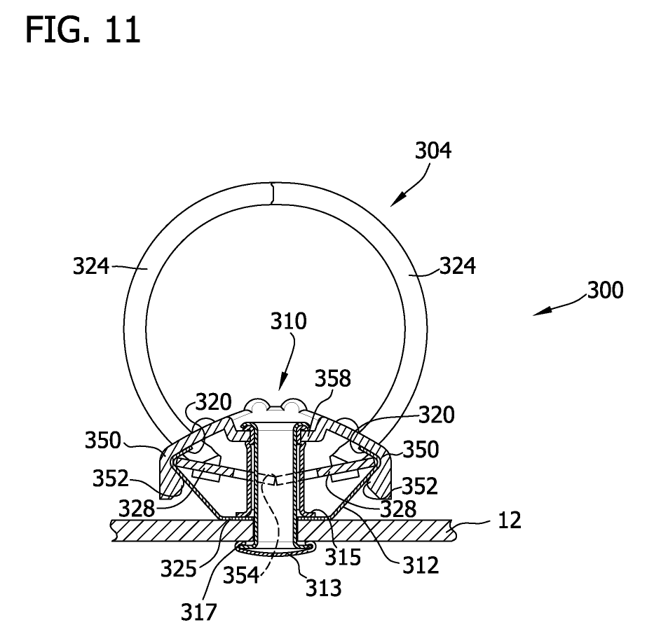

A third embodiment 300 of a ring binder mechanism with a plastic upper housing element 310 is illustrated in FIGS. 10 and 11. The third embodiment 300 is substantially identical to the second embodiment 200, and corresponding components are labeled with reference numbers that have been incremented by 100, i.e., that are in the 300's. Operation of the two embodiments 200 and 300 is identical.

The only difference between the second and third embodiments is that in the third embodiment 300, no support post extends from the thickened portion 358 surrounding the access holes 346. Rather, to support the upper housing element 310 and prevent it from crushing into the lower housing element, double-walled rivets 313 are used, with the double-walled rivets 313 clamping the thickened portions 358 at the upper ends of the rivets and with the lower housing element 312 being clamped to the support surface 12 between rivet flanges 315 and 317 at the lower ends of the rivets, as shown in FIG. 11.

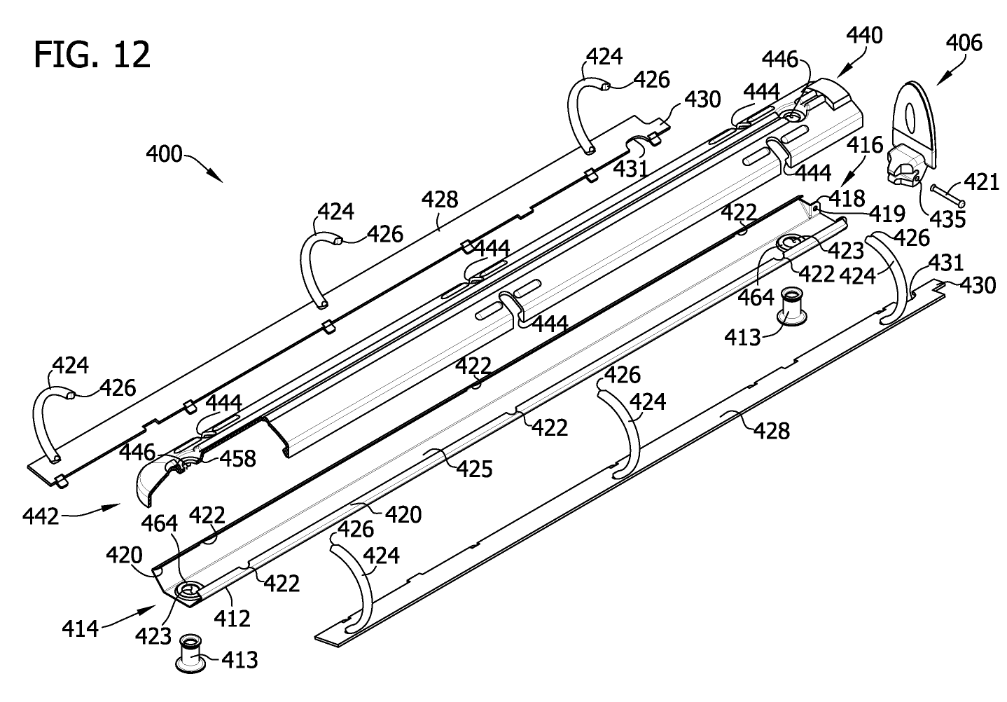

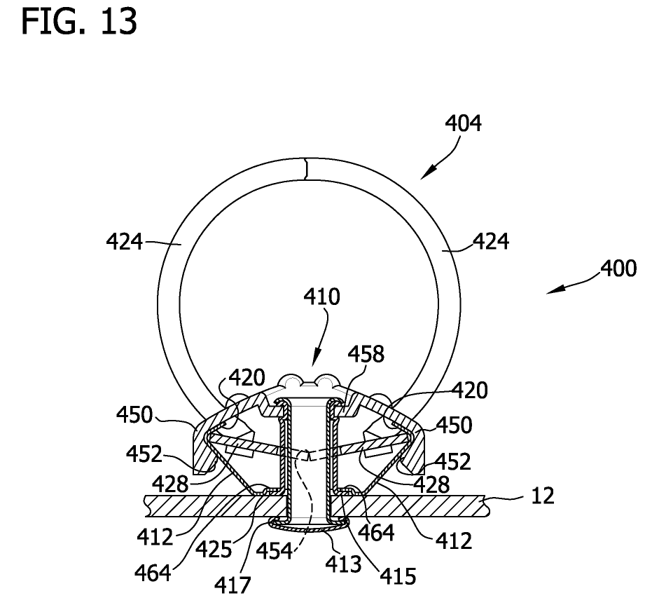

A fourth embodiment 400 of a ring binder mechanism with a plastic upper housing element 410 is illustrated in FIGS. 12 and 13. The fourth embodiment 400 is substantially identical to the third embodiment 300, and corresponding components are labeled with reference numbers that have been incremented by 100, i.e., that are in the 400's. Operation of the two embodiments 300 and 400 is identical.

The only difference between the third and fourth embodiments is that in the fourth embodiment the mechanism 400 has raised annular shoulders 464 surrounding the attachment holes 423 in the lower housing element 412. Thus, the rivet flanges 415 fit underneath the raised annular shoulders 464, between the bottom of the lower housing element 412 and the surface 12 to which the ring binder mechanism 400 is attached as shown in FIG. 13.

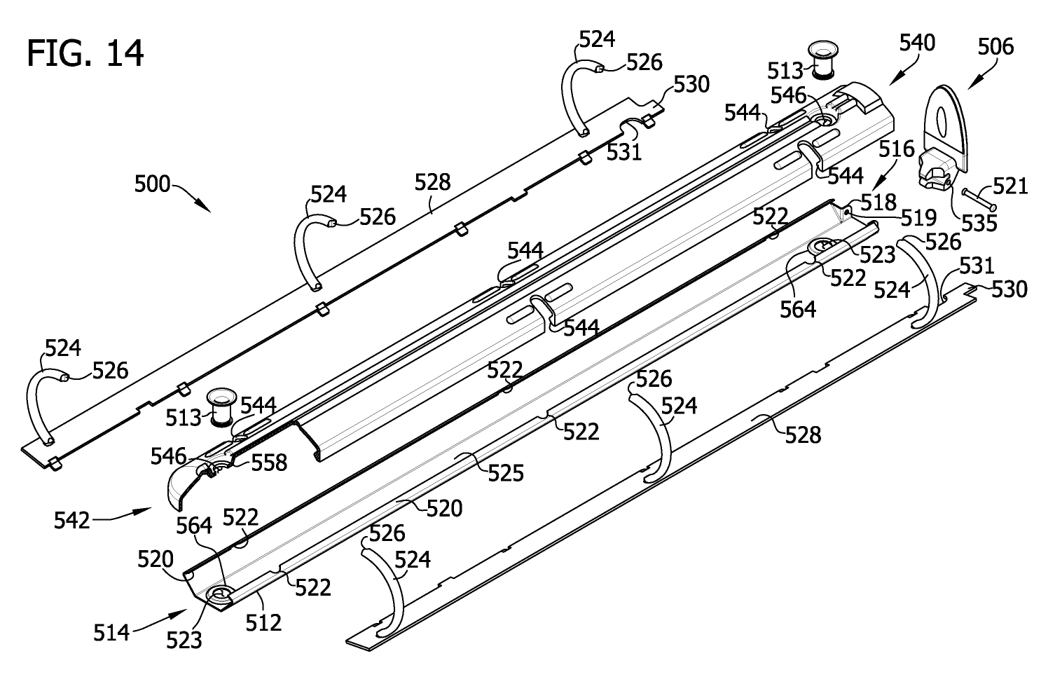

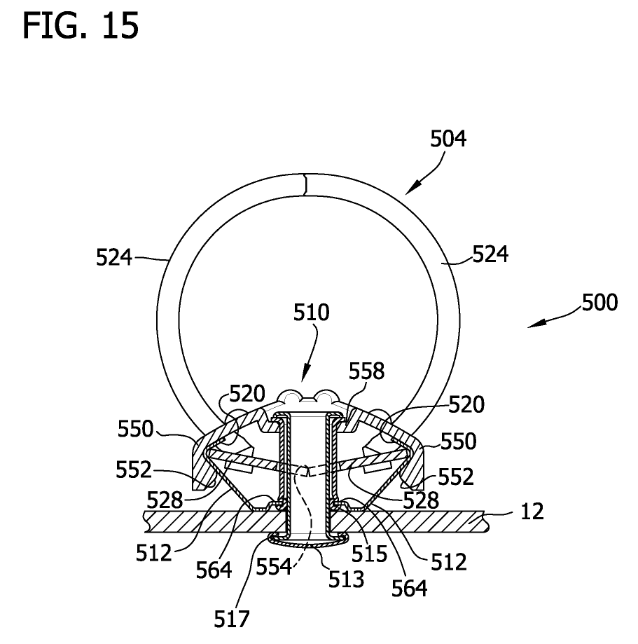

A fifth embodiment of a ring binder mechanism 500 with a plastic upper housing element 510 is illustrated in FIGS. 14 and 15. The mechanism 500 of this fifth embodiment is substantially identical to that of the fourth embodiment, and corresponding components are labeled with reference numbers that have been incremented by 100, i.e., that are in the 500's. Operation of the two mechanisms 400 and 500 is identical.

The difference between the fourth and fifth embodiments is in the height of the raised annular shoulders 564 surrounding the attachment holes 523 in the lower housing element 512 and in the manner in which the double-walled rivets 513 engage the various components together.

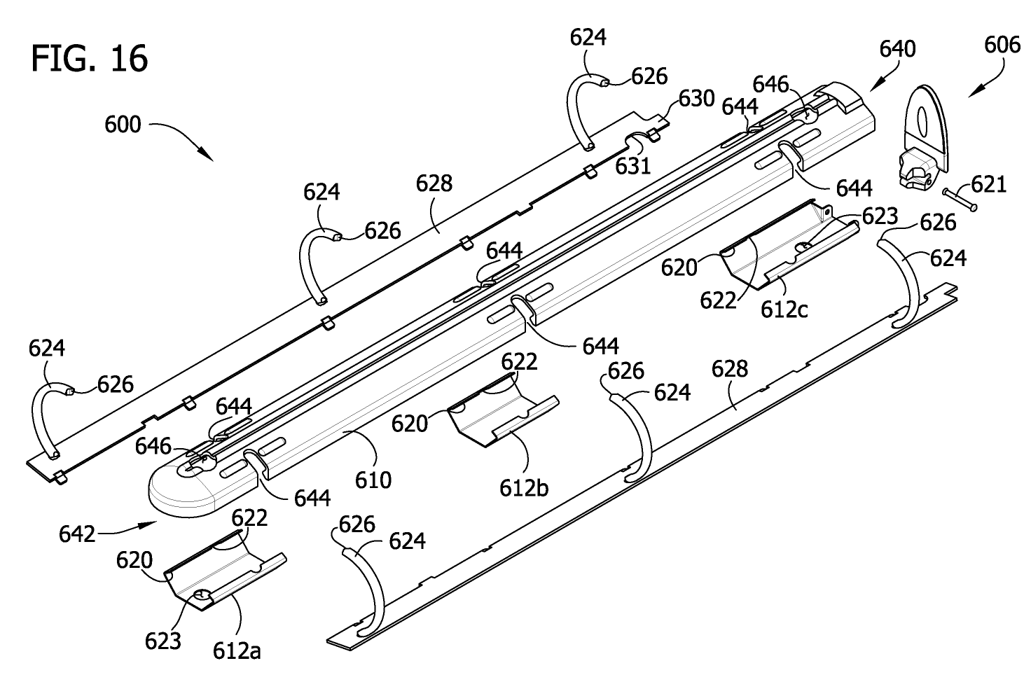

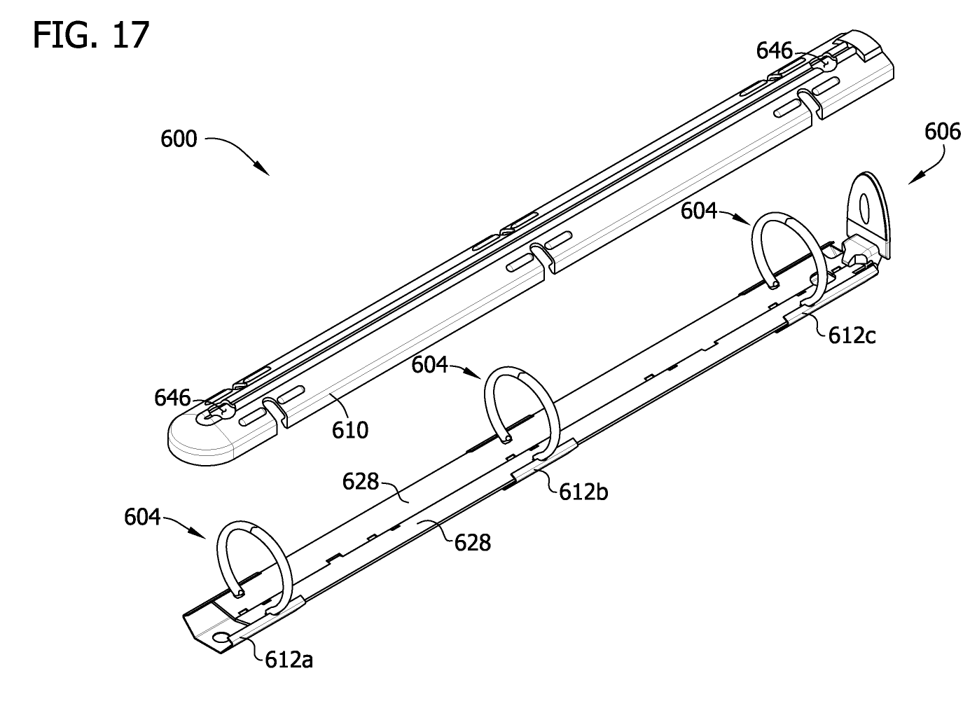

A sixth embodiment of a ring binder mechanism 600 with a plastic upper housing element 610 is shown in FIGS. 16 and 17. This mechanism 600 is generally identical to that of the first embodiment, and corresponding components are labeled with reference numbers that have been incremented by 500, i.e., that are in the 600's. Operation of the two mechanisms 100 and 600 is identical. The upper housing element 610 may be identical to any of the upper housing elements 110, 210, 310, 410, or 510.

The difference between the first and sixth embodiments is that in the sixth embodiment 600, the lower housing element is comprised of multiple pieces 612a, 612b, and 612c, the endmost ones of which (i.e., 612a and 612c) are secured to the structure on which the ring binder mechanism 600 is mounted. Suitably, one lower housing element piece is provided in the region of each ring 604, such that the number of lower housing element pieces is the same as the number of rings in the mechanism, e.g., two, three (as shown), four, etc. Advantageously, this configuration reduces material costs associated with the lower housing element.

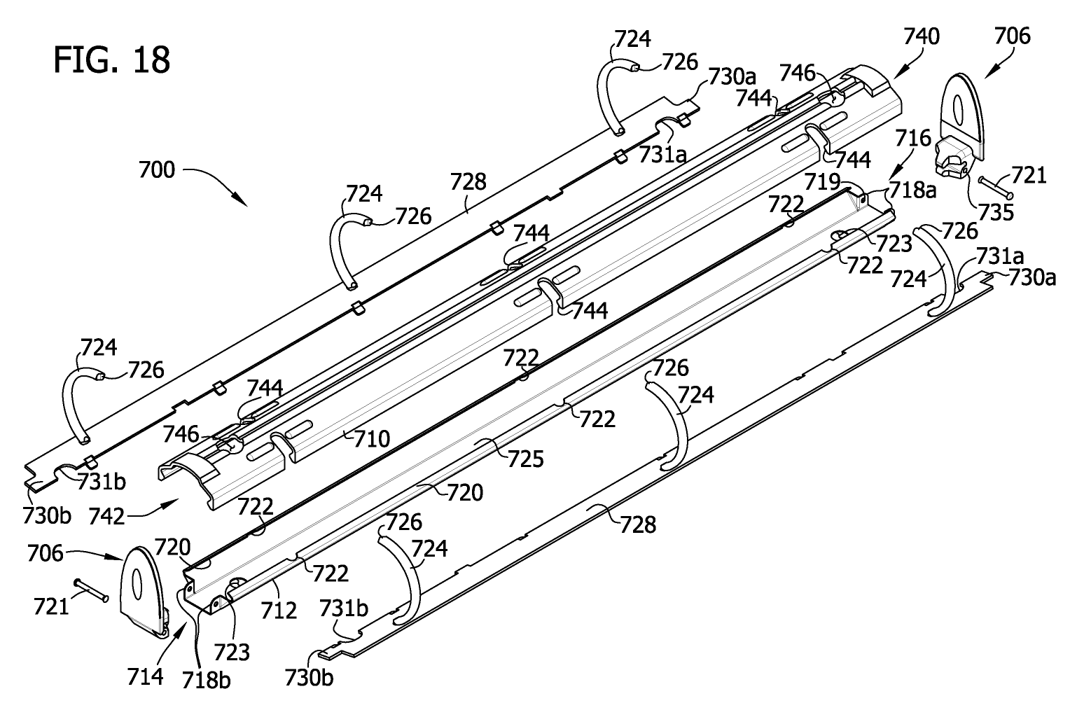

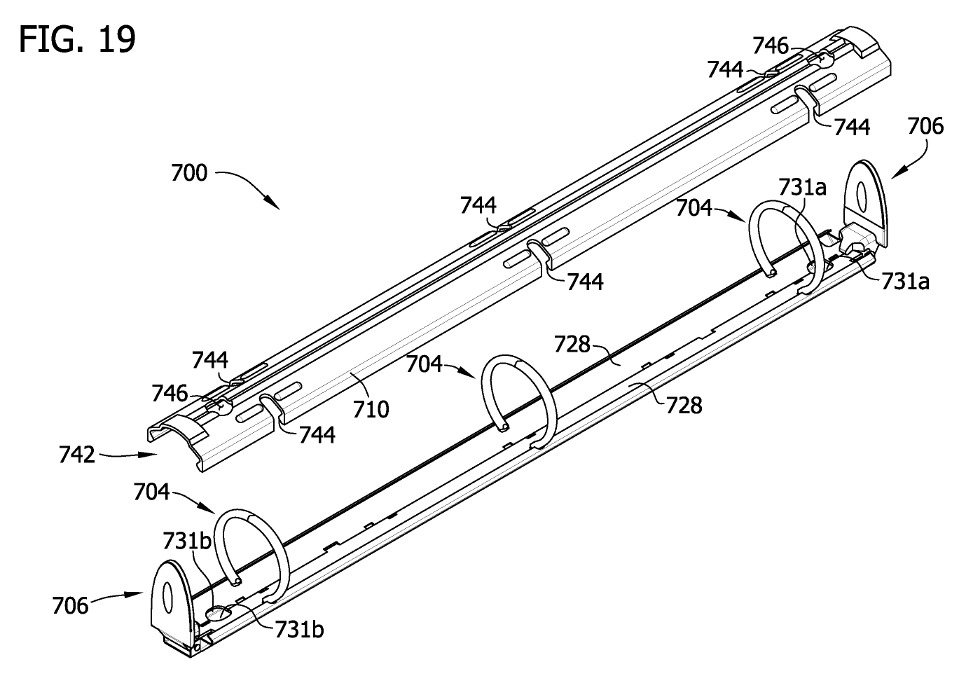

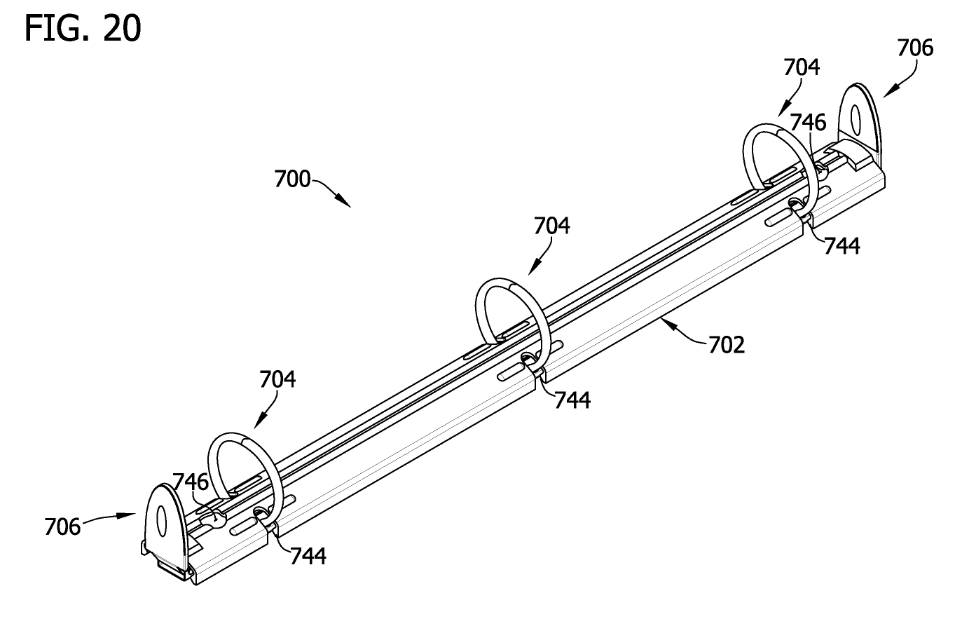

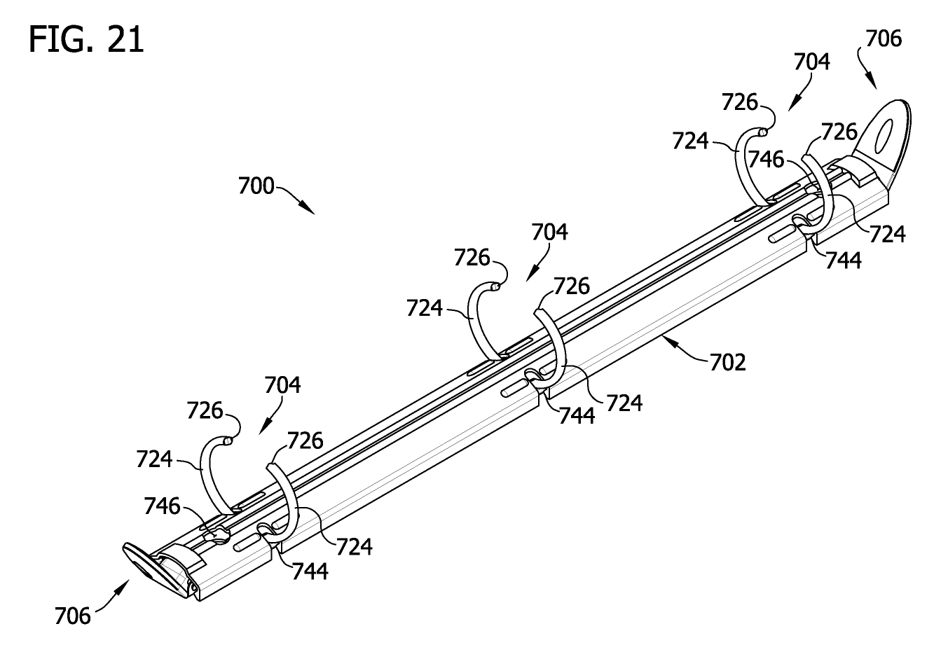

A seventh embodiment of a ring binder mechanism 700 with a plastic upper housing element 710 is illustrated in FIGS. 18-21. The ring binder mechanism 700 is substantially identical to that of the first embodiment, and corresponding components are labeled with reference numbers that have been incremented by 600, i.e., that are in the 700's. Operation of the two mechanisms 100 and 700 is essentially identical.

The difference between the first and seventh embodiments is that in this seventh embodiment, a lever 706 is mounted at each end of the ring binder mechanism 700 to increase actuation versatility. To support that feature, lever-mounting wall elements 718a, 718b are provided at each end 716, 714 of the lower housing element 712, and both ends 740, 742 of the upper housing element 710 are open (as compared to end 142 of the upper housing element 110 in the first mechanism 100, which is closed). Fingers 730a, 730b are provided at both ends of the hinge plates 728 (and are engaged by the levers 706 in the same manner as described above with respect the ring binder mechanism 100). Furthermore, cutouts 731a, 731b are formed in the inner longitudinal edges of the hinge plates 728 near both ends of the hinge plates to provide access to the attachment holes 723 near both ends of the housing.

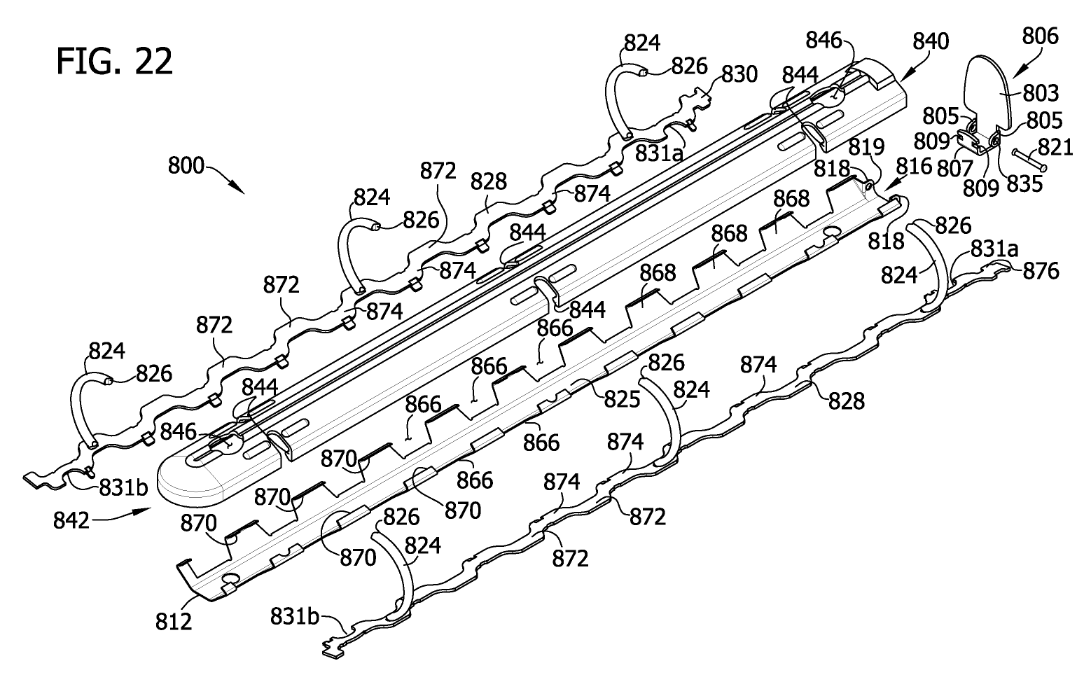

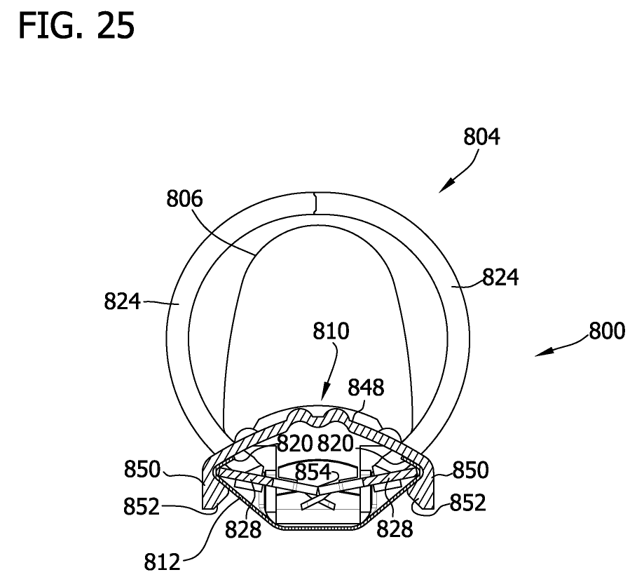

An eighth embodiment of a ring binder mechanism 800 with a plastic upper housing element 810 is illustrated in FIGS. 22-27. The eighth embodiment 800 substantially similar to the first embodiment, and corresponding components are labeled with reference numbers that have been incremented by 700, i.e., that are in the 800's. Operation of the mechanisms 100 and 800 is generally identical; structure that is different between the two embodiments is described below.

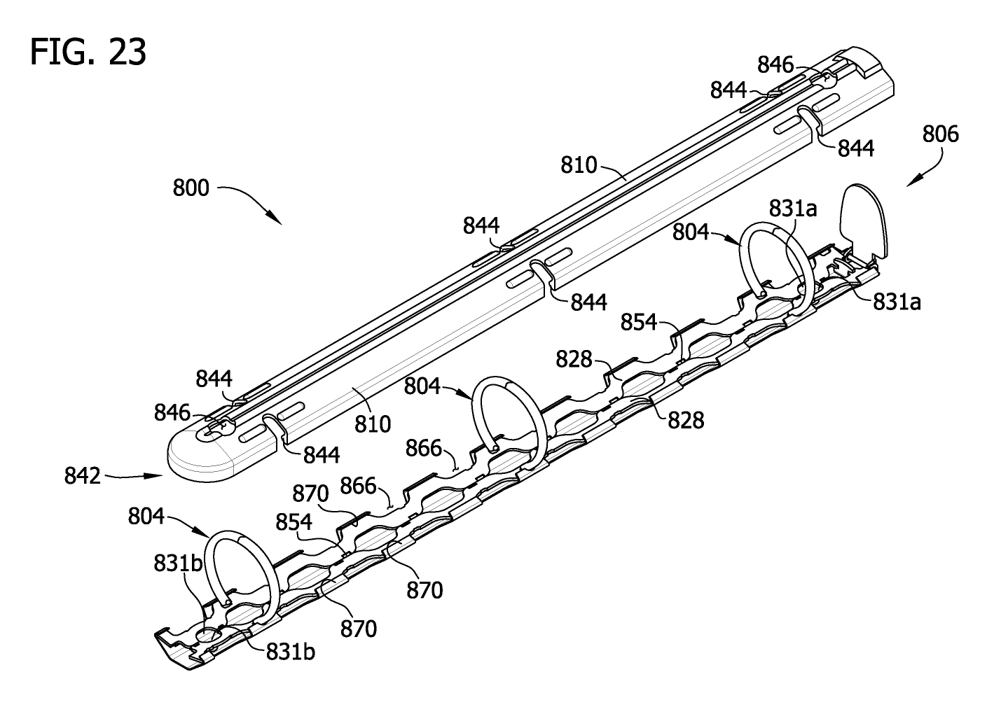

In particular, as best shown in FIGS. 22 and 23, the sidewalls of the lower housing element 812 have a series of notches 866 formed therein, extending along the length of the lower housing element 812. This defines a series of tabs 868 between the notches 862, extending along the length of the lower housing element 812. Accordingly, the bent-in rims are constituted by a plurality of bent-in rim segments 870 extending inwardly from each of the tabs 868. This configuration reduces material costs and increases manufacturing efficiency associated with producing the lower housing element 812, as multiple lower housing elements can be stamped from a sheet of metal with the tabs 868 of adjacent lower housing element “blanks” to be stamped from the sheet being interleaved.

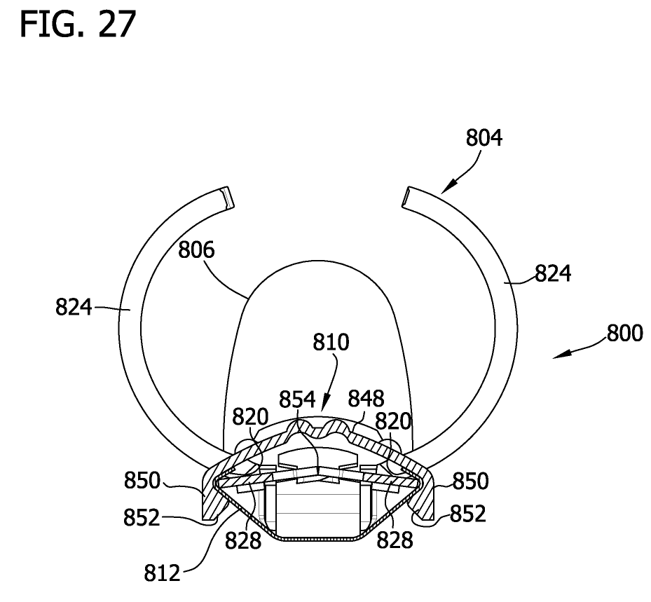

Similarly, the hinge plates 828 are constructed in a manner which reduces material costs and increases manufacturing efficiency in much the same way as costs are reduced and efficiency is increased with respect to the lower housing element 812. In particular, the hinge plates 828 may be referred to as “skeletonized”—i.e, reduced to a minimal amount of material—and are fabricated in generally sinusoidal or serpentine shapes, as illustrated in FIGS. 22 and 23, which consist of alternating peaks and valleys or crests and troughs 872, 874, respectively. As best shown in FIG. 23, the hinge plates 828 are retained in the lower housing element 812 by virtue of the laterally outer edges of the peaks/crests 872 being engaged under the bent-in rim segments 870, and the central hinge 854 is constituted by interleaved abutment of the laterally inner edges of the valleys/troughs 874 (as also shown in FIGS. 27 and 27).

Furthermore with respect to the hinge plates 828, rather than fingers, they include inwardly protruding tabs 876 (FIG. 22). The tabs 876 are positioned laterally outwardly on the hinge plates 828 by a sufficient amount that they do not abut against each other when the ring binder mechanism is assembled.

As shown in FIGS. 22, 24, and 26, the lever 806, which may conveniently be formed from a bent piece of material such as metal, has a generally J-shaped profile. The grip portion 832 of the lever is formed at the top of the upstanding stem portion of the “J,” and two ears 805 extend perpendicularly to the stem portion of the “J,” near the base of the “J,” with a mounting hole 835 formed in each ear 805. Across from the stem of the “J,” the upturned crook 807 of the “J” has a notch 809 formed in each side of it. The lever 806 is positioned at the longitudinal end 816 of the lower housing element 812, between the lever-mounting wall elements 818 with the mounting holes 835 in the ears 805 aligned with holes 819 in the wall elements 818. The lever 806 is pivotally mounted to the lower housing element 812 by means of pivot pin 821, which passes through the holes 819 and 835.

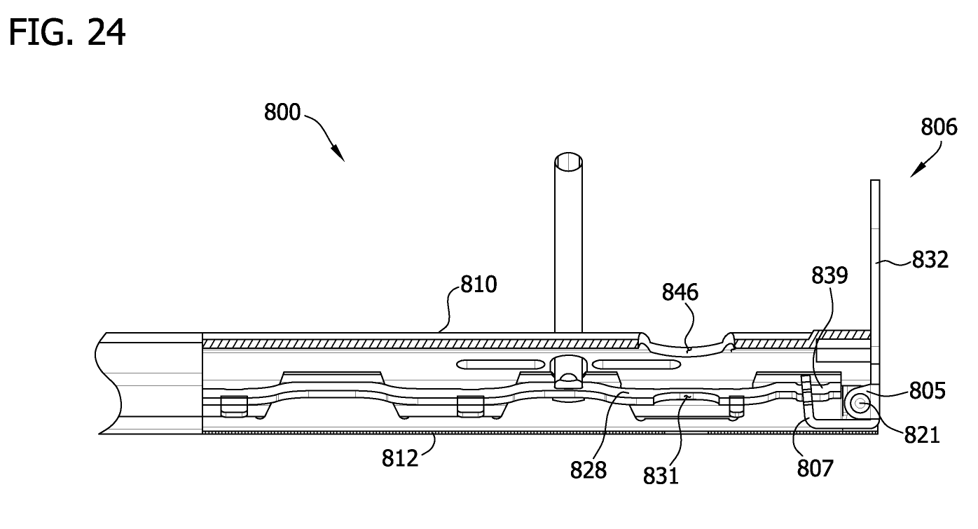

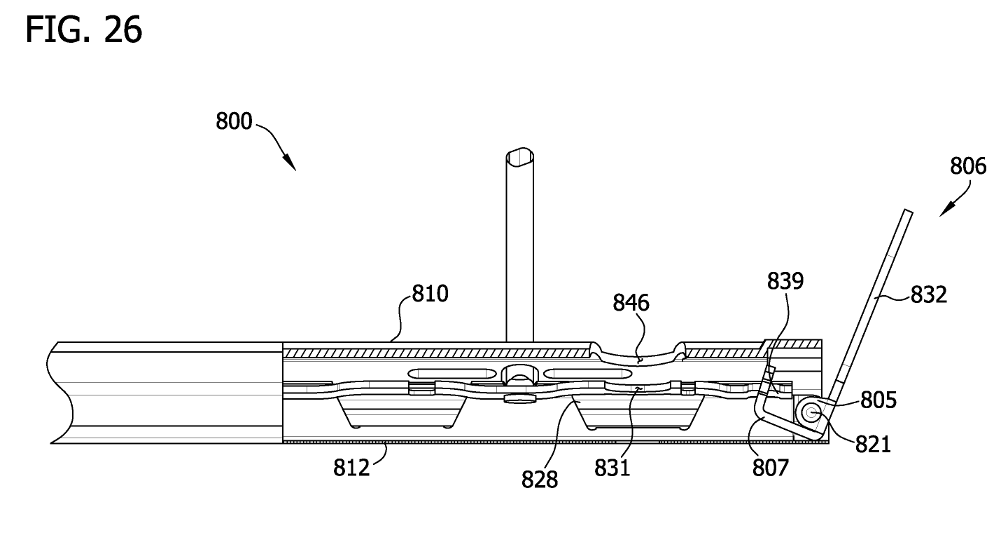

As best shown in FIG. 23, the inwardly protruding tabs 876 near the ends of the hinge plates 828 are positioned within the notches 809 in the sides of the upturned crook portion of the lever “J.” Lower surfaces of the notches 809 press against lower surfaces of the tabs 876 when the lever 806 is pivoted outwardly (i.e., to the right as shown in FIGS. 24 and 26) to open the ring binder mechanism 800; upper surfaces of the notches 809 press against upper surfaces of the tabs 876 when the lever is pivoted back inwardly (i.e., to the left as shown in FIGS. 24 and 26) to close the ring binder mechanism 800.

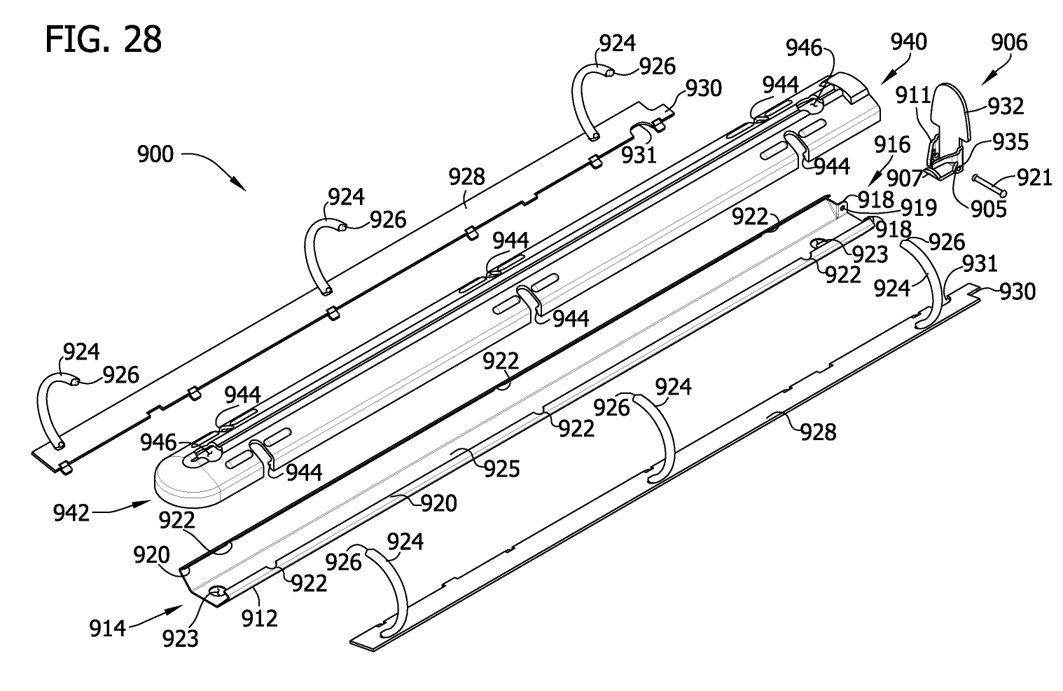

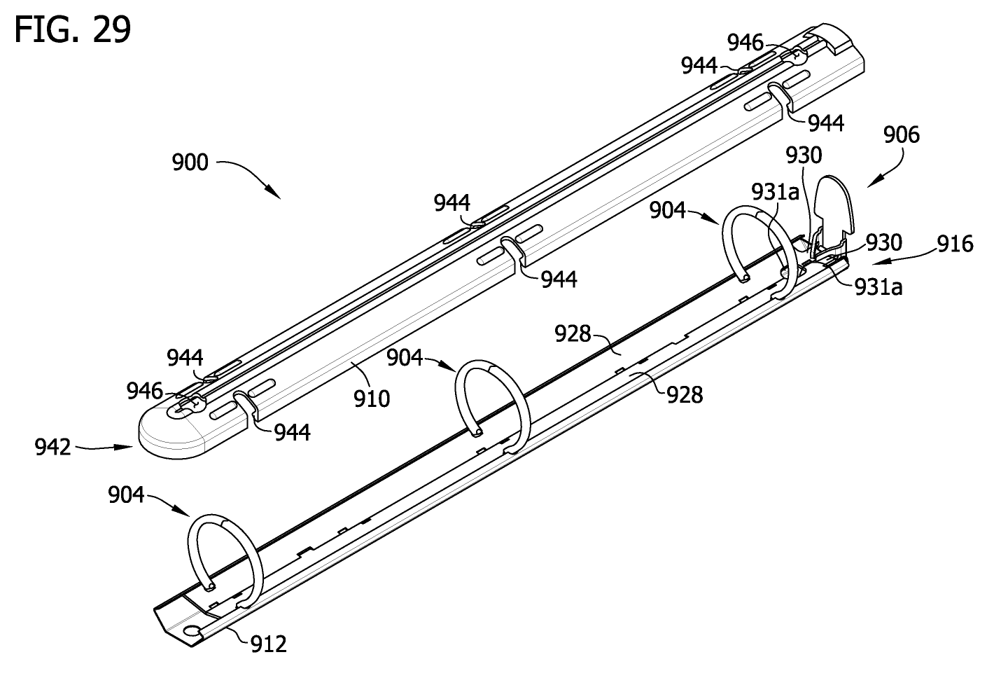

A ninth embodiment of a ring binder mechanism 900 with a plastic upper housing element 910 is illustrated in FIGS. 28-31. The ninth embodiment is substantially identical to the first embodiment, and corresponding components are labeled with reference numbers that have been incremented by 800, i.e., that are in the 900's. Operation of the two mechanisms 100 and 900 is identical.

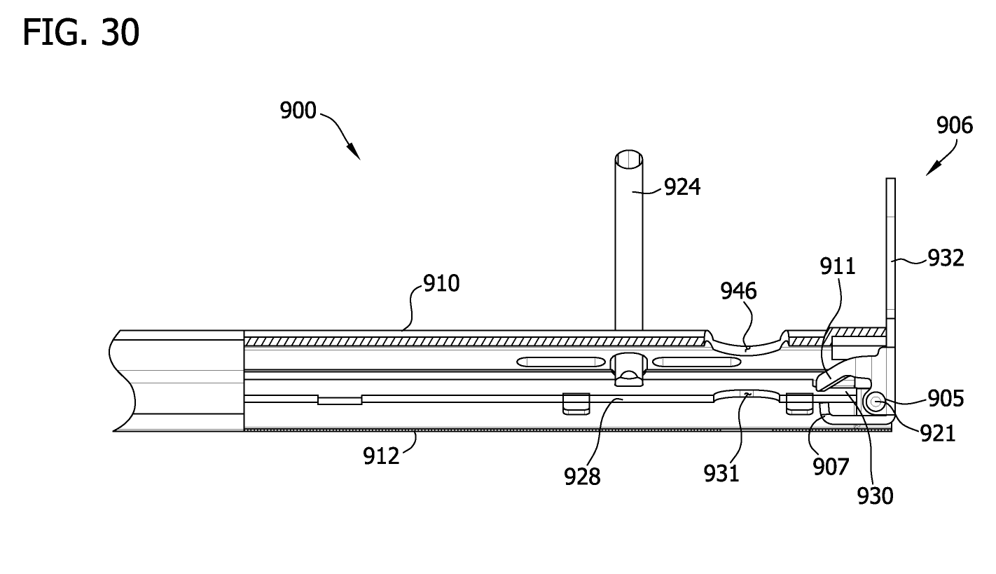

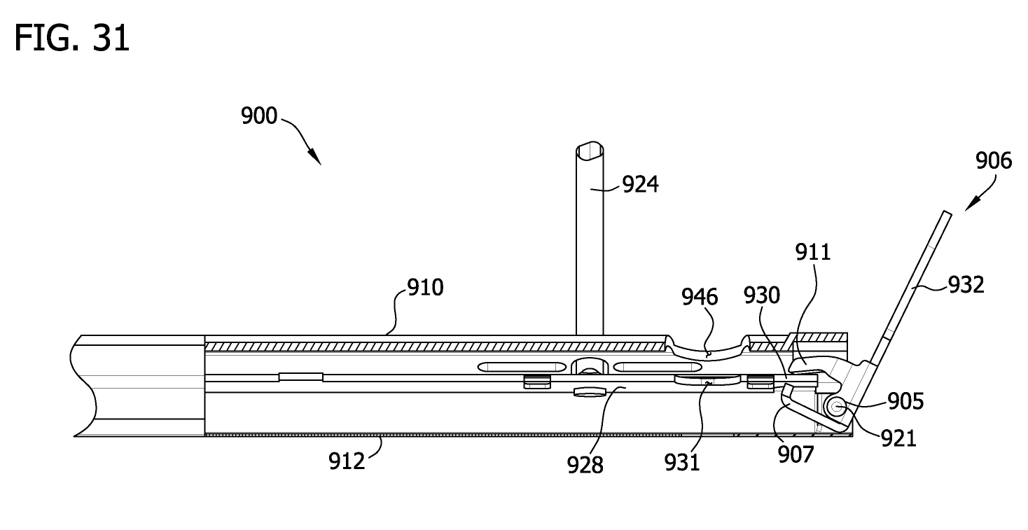

The only difference between the first and ninth embodiments is in the lever 906. The lever 906, which may conveniently be formed from a bent piece of material such as metal, has a generally J-shaped profile. The grip portion 932 of the lever is formed at the top of the upstanding stem portion of the “J,” and two ears 905 extend perpendicularly to the stem portion of the “J,” near the base of the “J,” with a mounting hole 935 formed in each ear 905. Additionally, an arm 911 extends forward from each side of the lever 906, just above each ear 905, and the arms 911 converge inwardly as shown in FIG. 28. The arms 911 extend forwardly from the stem of the “J” approximately the same distance as the base of the “J” extends forwardly, as best shown in FIGS. 30 and 31. The lever 906 is positioned at the longitudinal end 916 of the lower housing element 912, between the lever-mounting wall elements 918 with the mounting holes 935 in the ears 905 aligned with holes 919 in the wall elements 918. The lever 906 is pivotally mounted to the lower housing element 912 by means of pivot pin 921, which passes through the holes 919 and 935.

Fingers 930 extending from the hinge plates 928 extend into the gap between the arms 911 and the tip of the upturned crook portion 907 of the lever “J.” The upper surface of the tip of the crook presses against lower surfaces of the fingers 930 when the lever 906 is pivoted outwardly (i.e., to the right as shown in FIGS. 30 and 31) to open the ring binder mechanism 900; lower surfaces of the ends of the arms 911 press against upper surfaces of the fingers 930 when the lever is pivoted back inwardly (i.e., to the left as shown in FIGS. 30 and 31) to close the ring binder mechanism 900.

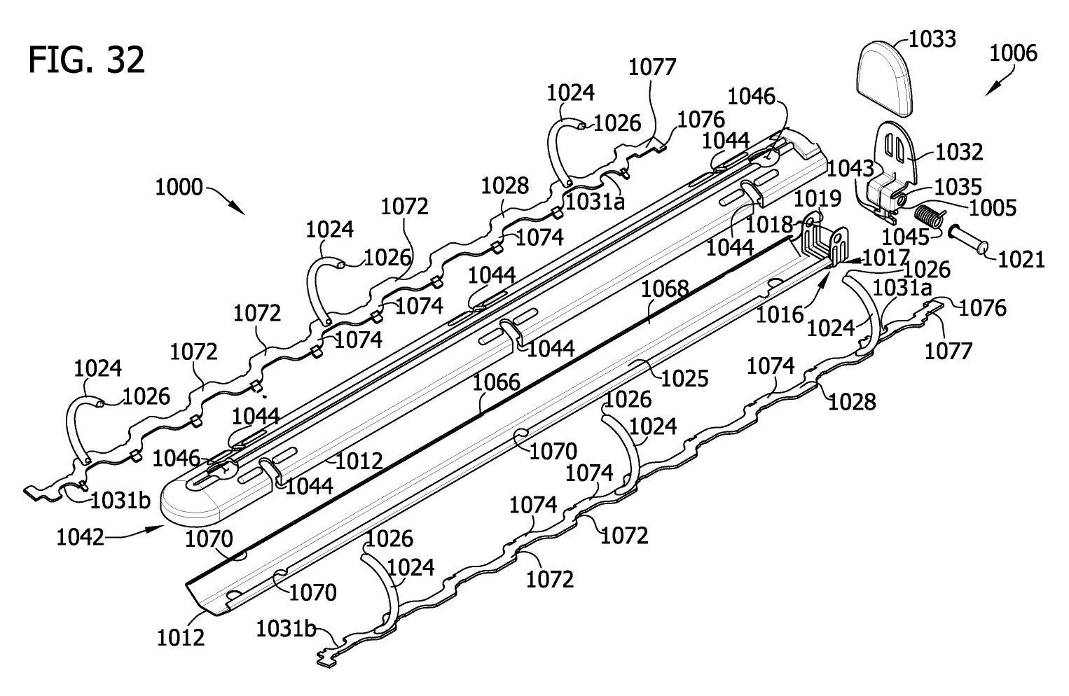

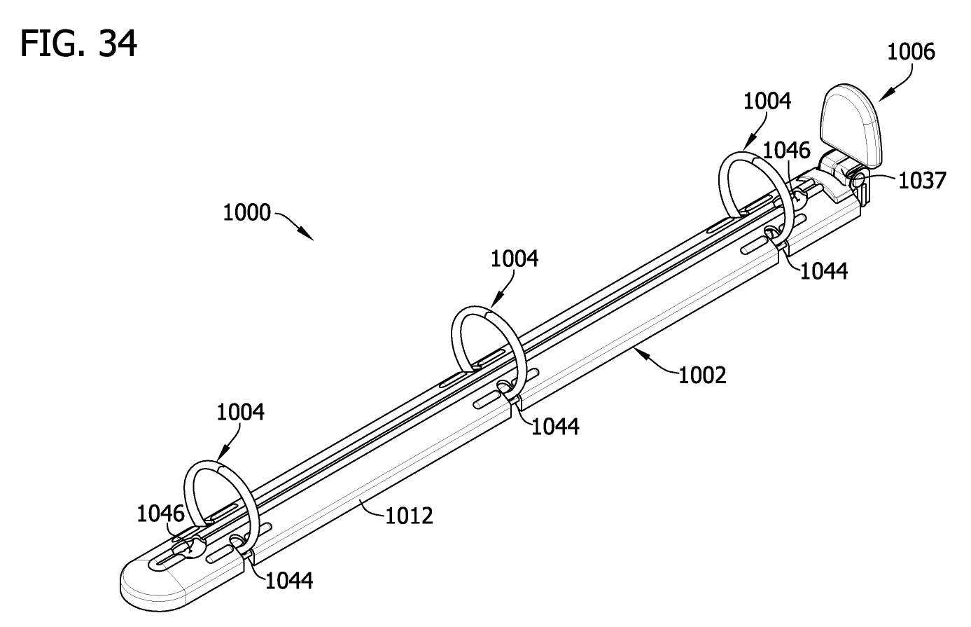

FIGS. 32-39 illustrate a tenth embodiment of a ring binder mechanism with a plastic upper housing element 1010. The tenth embodiment is substantially similar to the first embodiment 100, and corresponding components are labeled with reference numbers that have been incremented by 900, i.e., that are in the 1000's. Overall operation of the two mechanisms 100 and 1000 is essentially the same.

This tenth embodiment includes skeletonized hinge plates 1028 that are virtually identical to the hinge plates 828 of the eighth embodiment 800 and that include inwardly protruding tabs 1076. Like the hinge plates 828 of the eighth embodiment 800, the tabs 1076 are positioned laterally outwardly on the hinge plates 1028 by a sufficient amount that they do not abut against each other when the ring binder mechanism is assembled.

The lower housing element 1012, on the other hand, does not have a series of tab-defining notches in the sidewalls as does the lower housing element 812 of the eighth embodiment 800 (although it could, if desired). Rather, the lower housing element 1012 is similar to the lower housing element 112 of the first embodiment 100. The lower housing element 1012 differs from that lower housing element 112, however, in the specific arrangement of the longitudinal end 1016. In particular, the longitudinal end 1016 includes an end extension portion 1017, and the lever-mounting wall elements 1018 extend vertically from the end extension portion 1017. A hole 1019 is formed in each of the lever-mounting wall elements 1018.

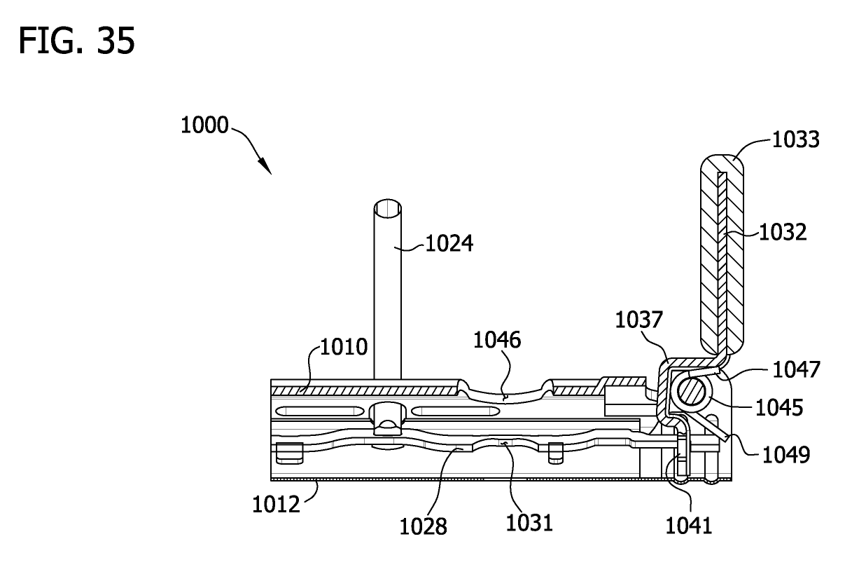

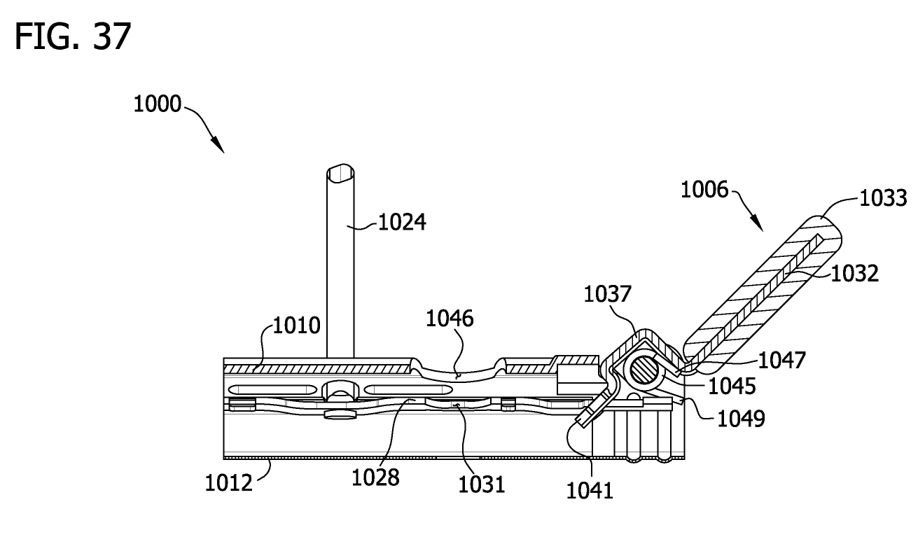

The lever 1006 in the tenth embodiment 1000 is somewhat different in configuration than those described previously. As best shown in FIGS. 35 and 37, the lever 1006, which may conveniently be formed from a bent piece of material such as metal, includes an upstanding grip 1032. (The grip 1032 may include a plastic or rubber grip cover 1033 to improve comfort, as shown, if so desired.) A protruding bulge-out portion 1037 is formed at the base of the grip 1032, and a tab 1041 depends from the bottom wall of the bulge-out portion 1037. A notch 1043 is formed in either side of the tab 1041. Bent-back ears 1005 are provided on either side of the bulge-out portion 1037, extending back from the front wall of the bulge-out portion toward the grip 1032, and a hole 1035 is formed in each ear 1005.

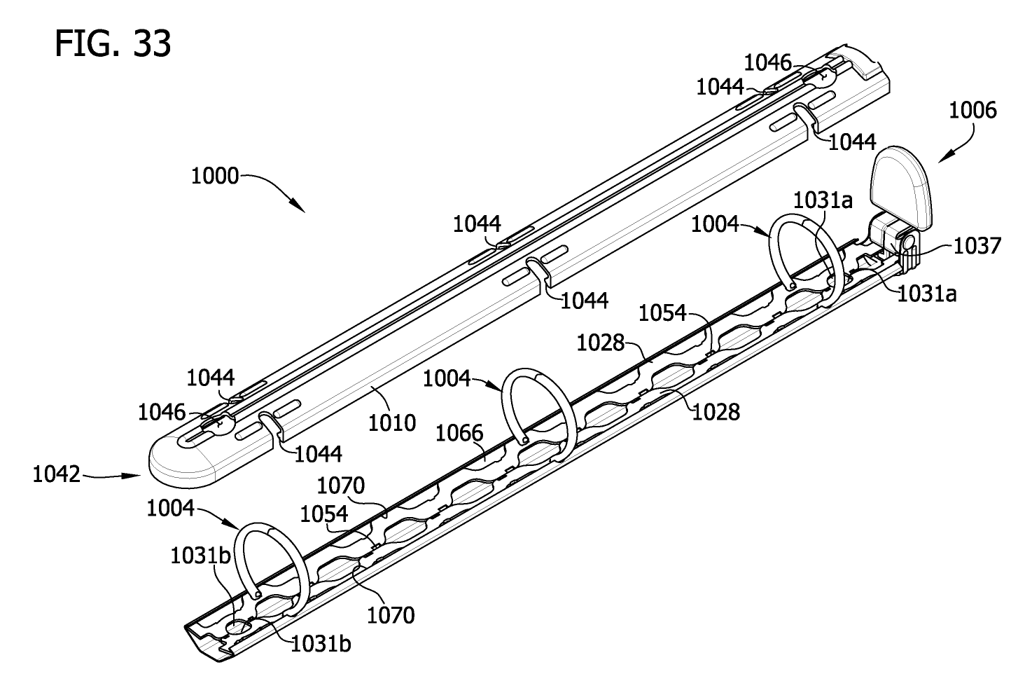

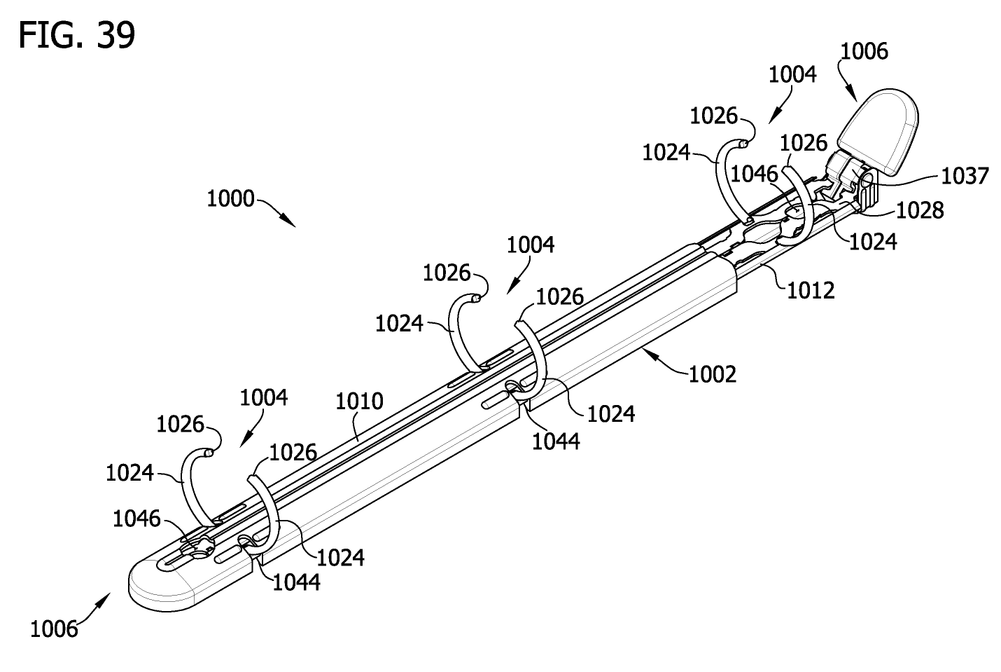

The lever 1006 is positioned at the longitudinal end 1016 of the lower housing element 1012 between the wall elements 1018, as best shown in FIGS. 33 and 39, with the holes 1035 in the ears 1005 aligned with the holes 1019 in the wall elements 1018. A pivot pin 1021 passes through the holes 1035 and 1019, behind the bulge-out portion 1037, to pivotally attach the lever 1006 to the lower housing element 1012. When the ring binder mechanism 1000 is assembled, the ends 1077 of the hinge plates 1028 fit within the notches 1043 in the sides of the tab 1041 depending from the lever bulge-out portion, with the hinge plate tabs 1076 positioned behind the depending tab 1041. This configuration prevents the lever 1006 from pivoting too far forward, i.e., in a direction away from the opening direction.

As shown in FIGS. 35 and 37, a torsion spring 1045 is provided around the pivot pin 1021, between the bent-back ears 1005. One end 1047 of the torsion spring 1045 bears against the undersurface of the top wall of the lever bulge-out portion 1037, generally beneath the grip 1032, and the other end 1049 of the torsion spring 1045 bears against the very end of one of the hinge plates 1028. The torsion spring 1045 biases the lever 1006 toward the upright position, as shown in FIG. 35.

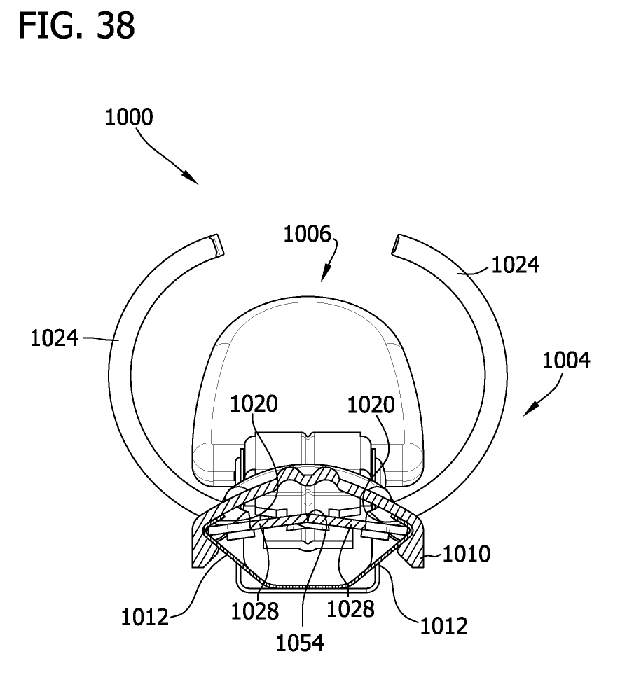

To open the ring binder mechanism 1000, the lever 1006 is pivoted outwardly, i.e., to the right as shown in FIGS. 35 and 37. As the lever 1006 pivots, bottom surfaces of the notches 1043 in the depending tab 1041 press against lower surfaces of the ends of the hinge plates 1028. Depending on the specific geometry of the hinge plates 1028, the end portions of the hinge plates may flex upward slightly relative to the majority of the length of the hinge plates before the hinge plates are driven through their co-planar position, thus allowing the lever 1006 to pivot outwardly by a slight amount before the rings 1004 actually open. If the lever 1006 is released before the hinge plates pass through their co-planar position, the hinge plates will relax and the torsion spring 1045 will return the lever 1006 to its upright position. Given sufficient continued pressure, however, the hinge plates will overcome the spring force generated by the lower housing element 1012 and pivot into their open position, as shown in FIGS. 37 and 38. In that position, the return torsional force generated by the torsion spring 1045 is insufficient to overcome the spring force of the of the lower housing element 1012, and the ring binder mechanism 1000 will remain in the open position.

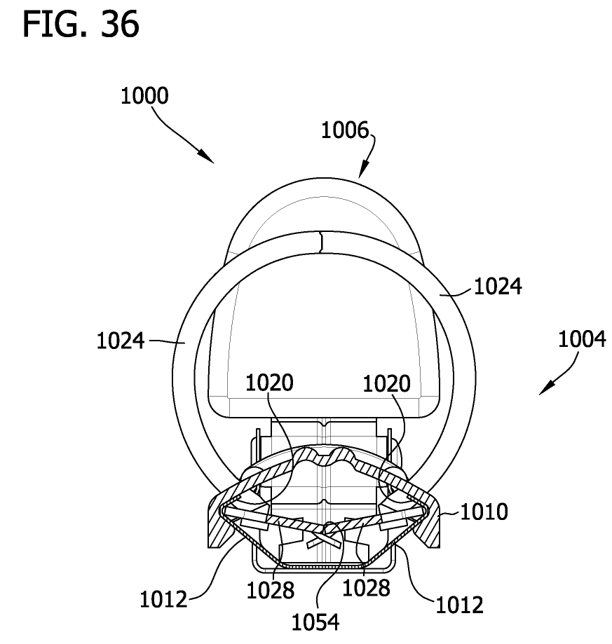

The ring binder mechanism 1000 may then be closed by pivoting the lever 1006 back toward the upright position, i.e., to the left as shown in FIGS. 35 and 37. As the lever 1006 pivots, upper surfaces of the notches 1043 in the depending tab 1041 press against upper surfaces of the ends of the hinge plates 1028 to drive the hinge plates 1028 back to their closed position, as shown in FIG. 36.

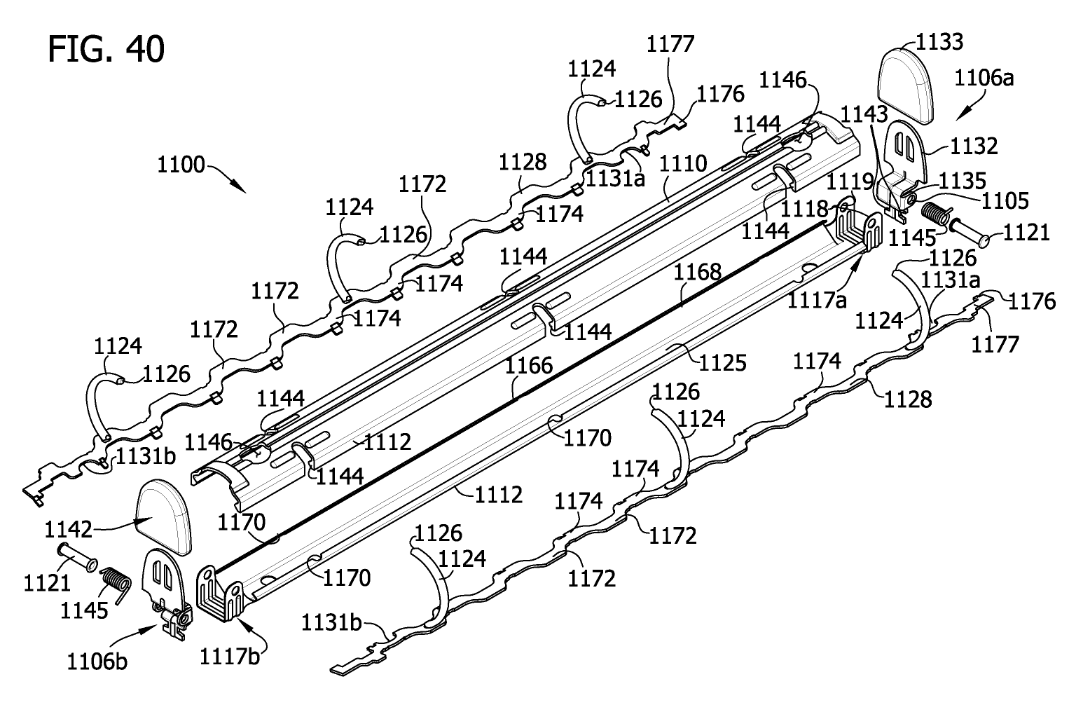

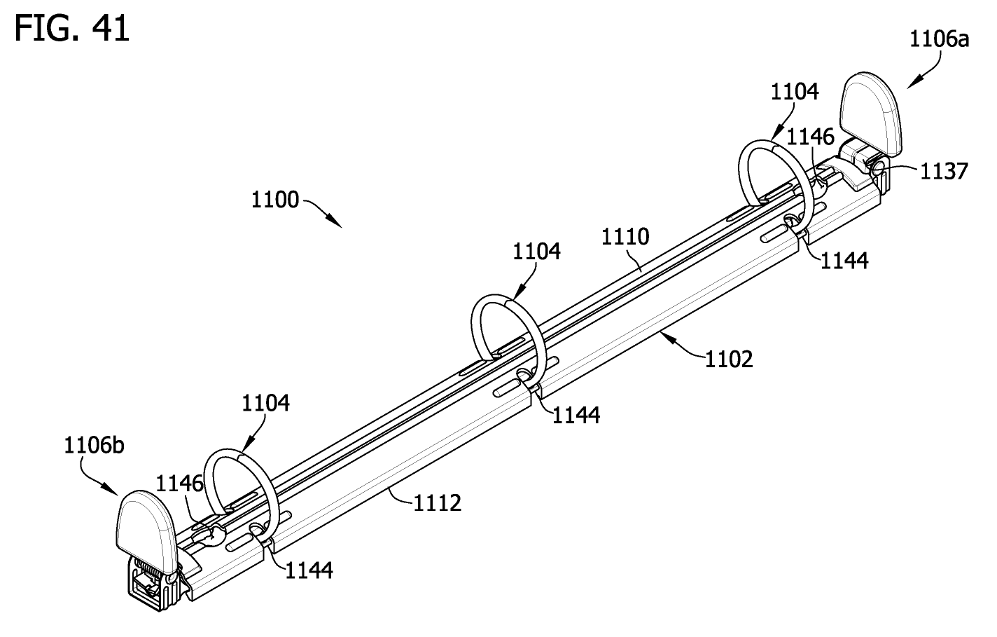

An eleventh embodiment of a ring binder mechanism 1100 with a plastic upper housing element 1110 is illustrated in FIGS. 40 and 41. The eleventh embodiment is virtually identical to the tenth embodiment 1000, and corresponding components have been labeled with reference numbers that have been incremented by 100, i.e., in the 1100's.

The ring binder mechanism 1100 differs from that of the tenth embodiment in that it includes a lever 1106a, 1106b at each end of the housing. An end extension portion 1117a, 1117b is provided at each longitudinal end of the lower housing element 1112, with each end extension portion 1117a, 1117b being identical to the end extension portion 1017 in the tenth embodiment. Each lever 1106a, 1106b is identical to, is mounted in the end extension portion of and operates in the same manner as the lever 1006 of the ring binder mechanism 1000 of the tenth embodiment. Thus, opening and closing of the ring binder mechanism 1100 may be effected from either end of the mechanism.

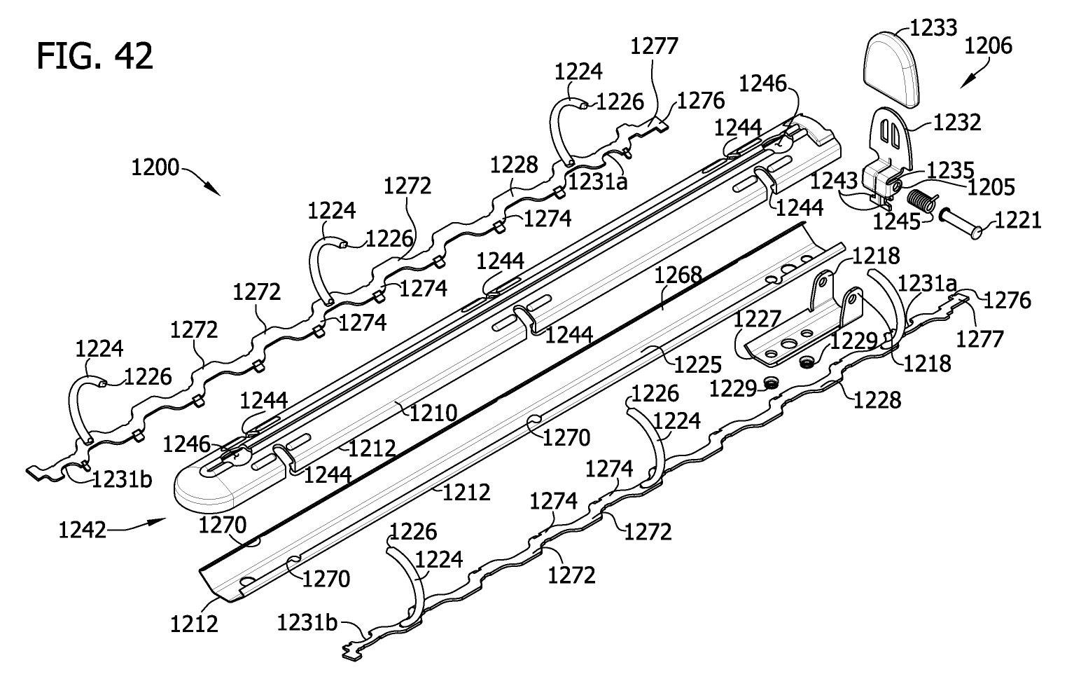

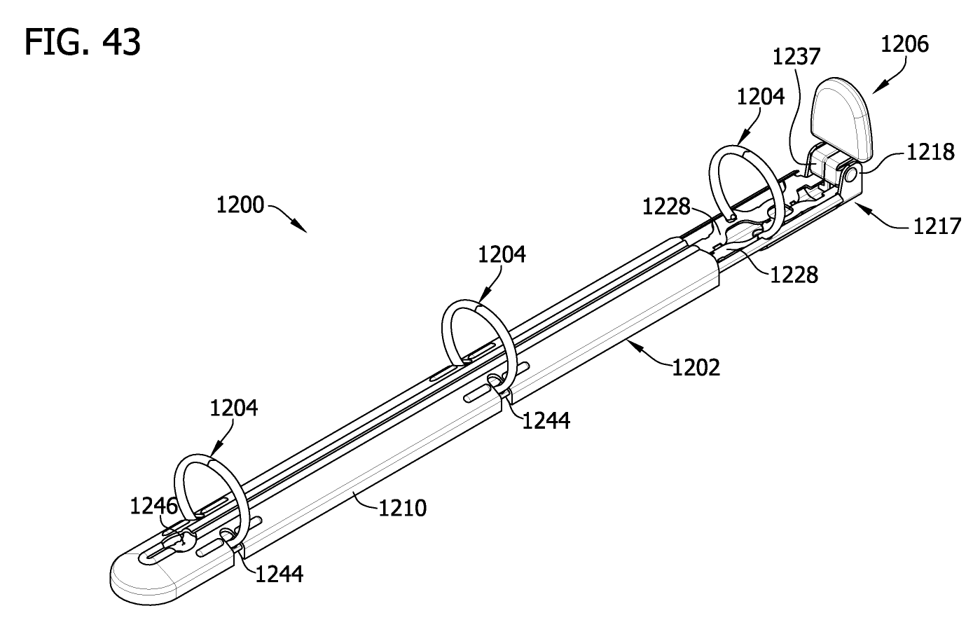

FIGS. 42-44 illustrate a twelfth embodiment of a ring binder mechanism 1200 with a plastic upper housing element 1210. The ring binder mechanism 1200 is virtually identical to that of the tenth embodiment, and corresponding components have been labeled with reference numbers that have been incremented by 200, i.e., in the 1200's. Operation of the ring binder mechanism 1200 is identical to operation of that of the tenth embodiment.

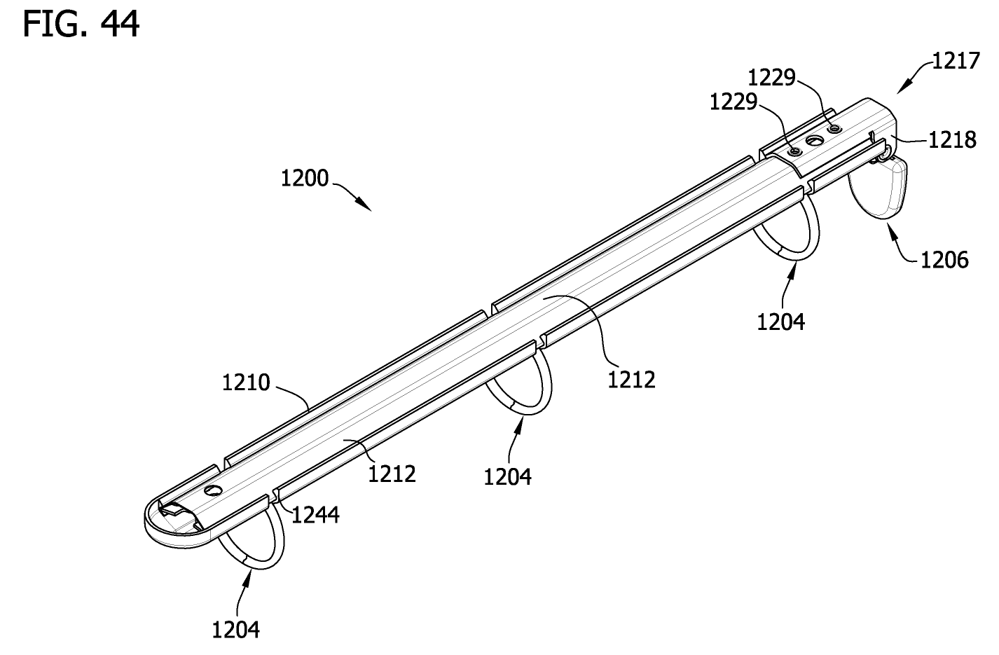

The difference between the tenth and twelfth embodiments is that in the twelfth embodiment, the end extension portion 1217 of the lower housing element is provided by means of a separate extension piece 1227, which is attached to the underside of the lower housing element 1212, e.g., by means of rivets 1229 as shown in FIG. 44. The lever 1206 is configured the same as the lever 1006 of the ring binder mechanism 1000. It mounts to the lever-mounting wall elements 1218 and engages the ends of the hinge plates 1228.

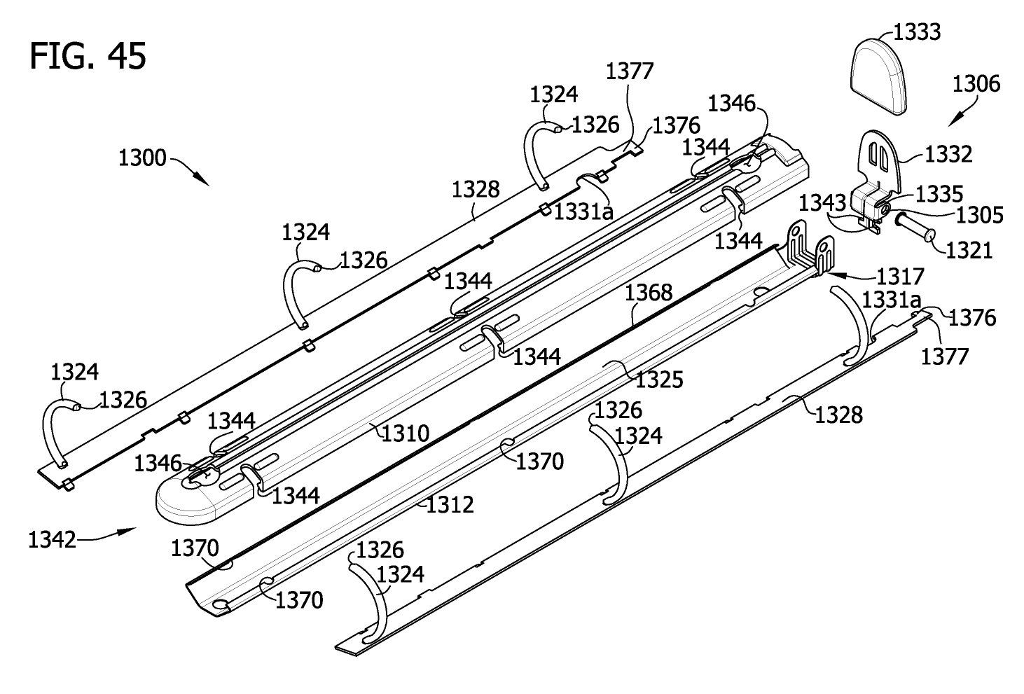

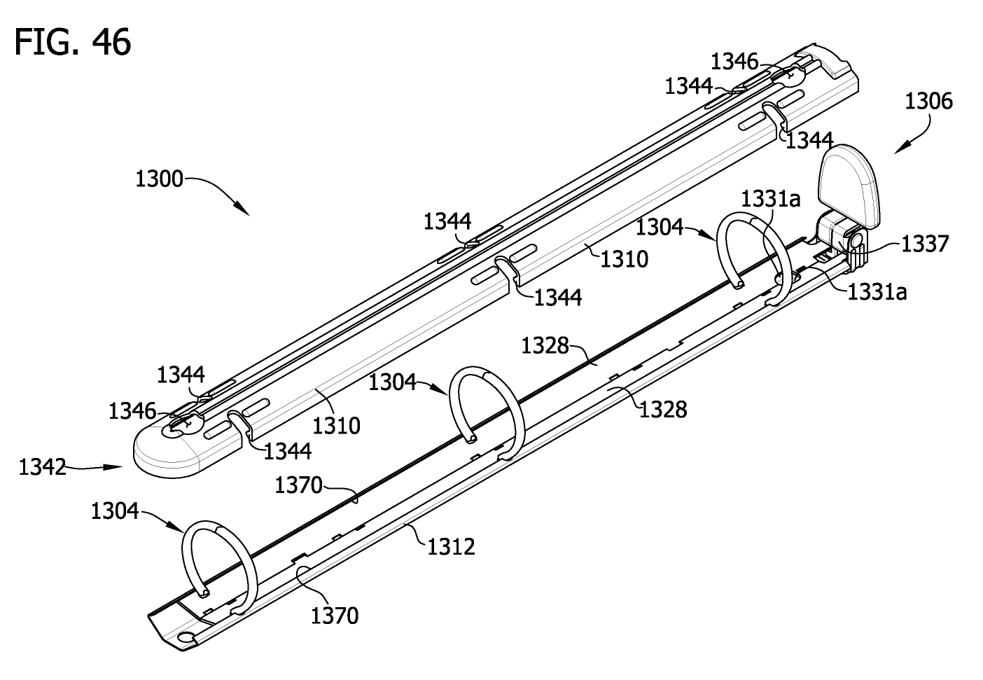

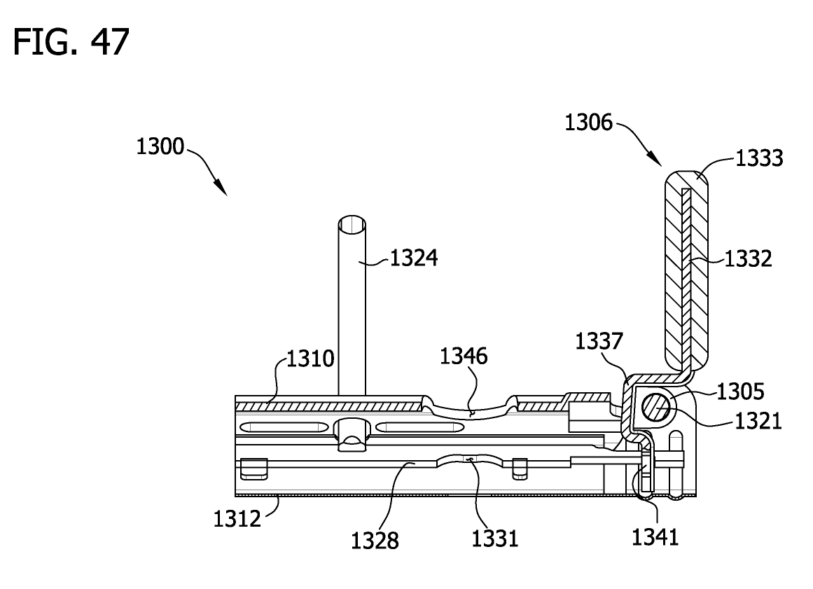

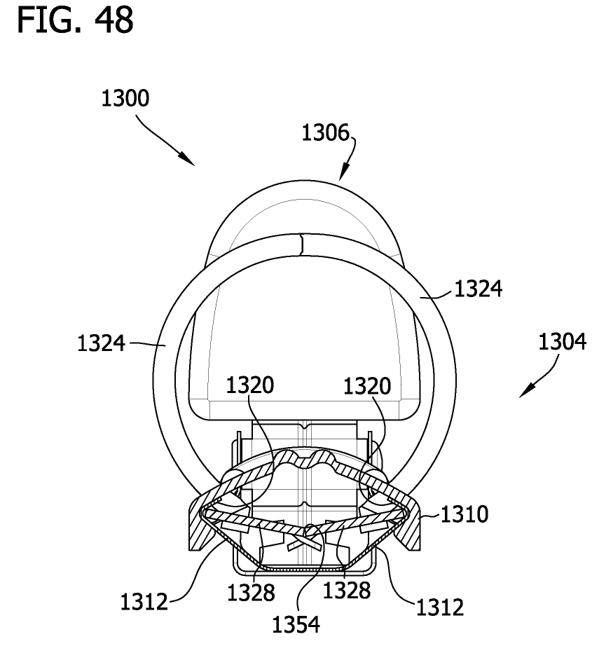

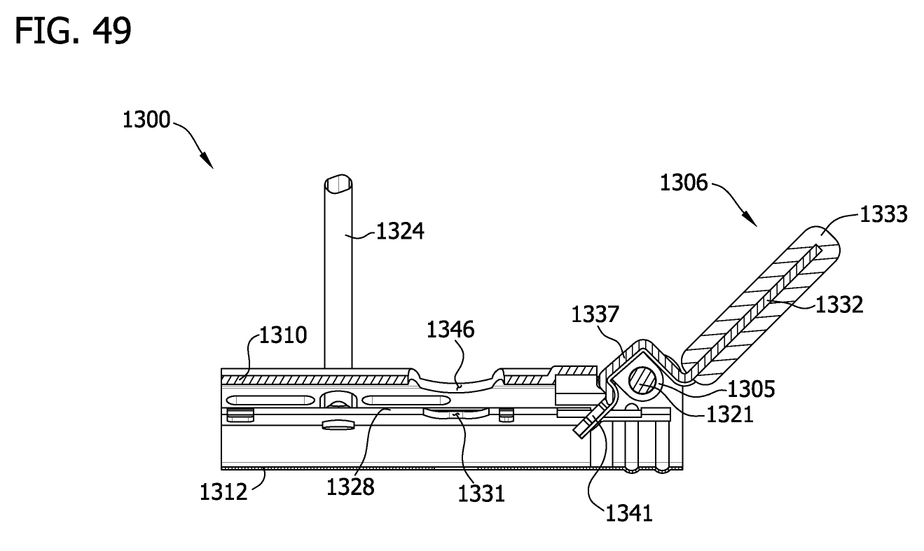

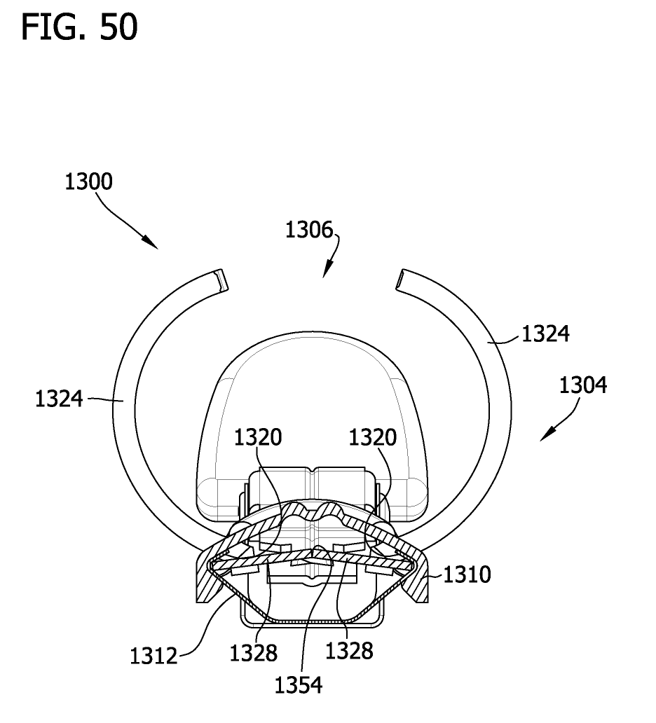

A thirteenth embodiment of a ring binder mechanism 1300 with a plastic upper housing element 1310 is illustrated in FIGS. 45-50. The thirteenth embodiment is virtually identical to the tenth embodiment, and corresponding components have been labeled with reference numbers that have been incremented by 300, i.e., in the 1300's. Operation of the ring binder mechanism 1300 is virtually identical to operation of the ring binder mechanism 1000 of the tenth embodiment.

The difference between the tenth and thirteenth embodiments is that in the thirteenth embodiment, the hinge plates 1328 are not “skeletonized.” Rather, they are formed as generally elongated, rectangular plates. The ends 1377 and inwardly protruding tabs 1376 of the hinge plates 1328 are, however, essentially identical to those of the hinge plates 1028 in the tenth embodiment 1000. The lever 1306 is identical to the lever 1006 of the tenth embodiment and is mounted to the end extension portion 1317 in the same manner as in the tenth embodiment, but the ring binder mechanism 1300 does not include a torsion spring around the pivot pin 1321. The ends 1377 of the hinge plates 1328 are engaged by the lever 1306 in the same manner as the ends of the hinge plates are engaged by the lever in the ring binder mechanism 1000; accordingly, opening and closing operation of the lever 1306 is the same in the thirteenth embodiment as it is in the tenth embodiment, except for the fact that no lever-returning spring action is provided in the event the lever is released before the rings open.

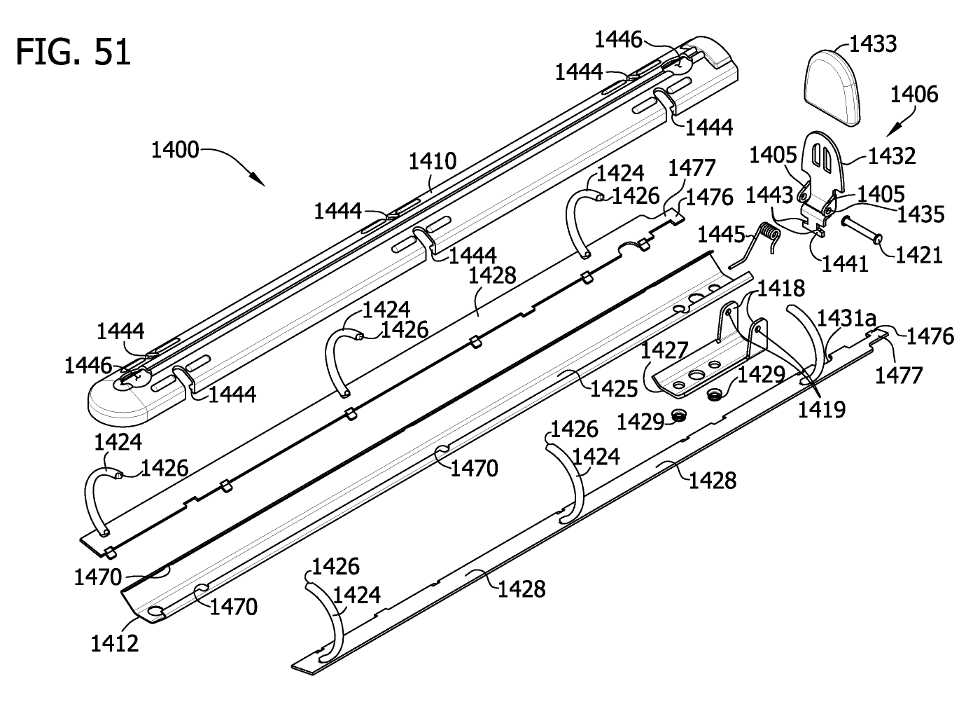

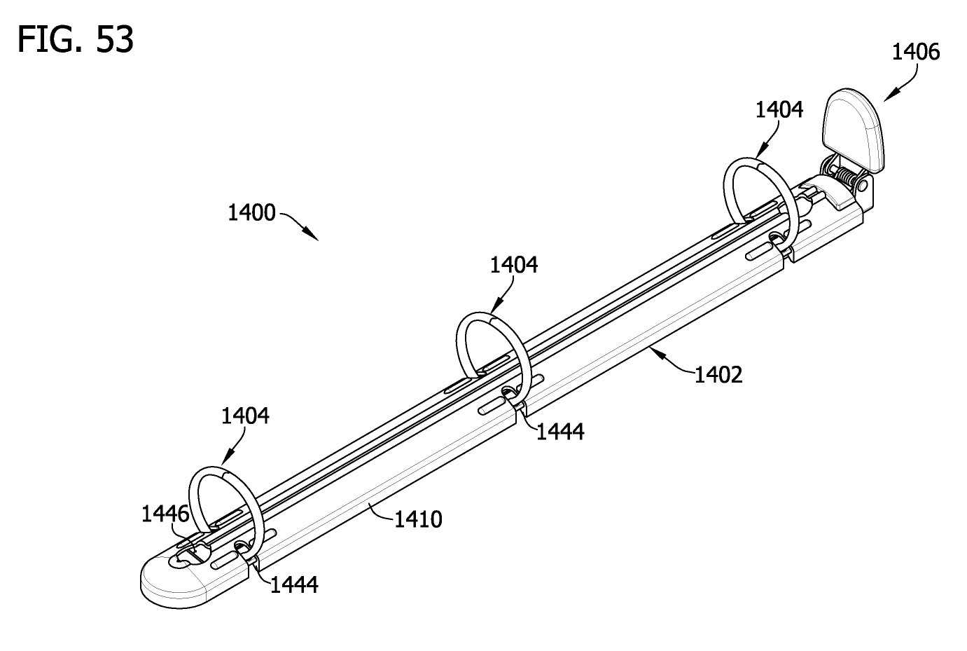

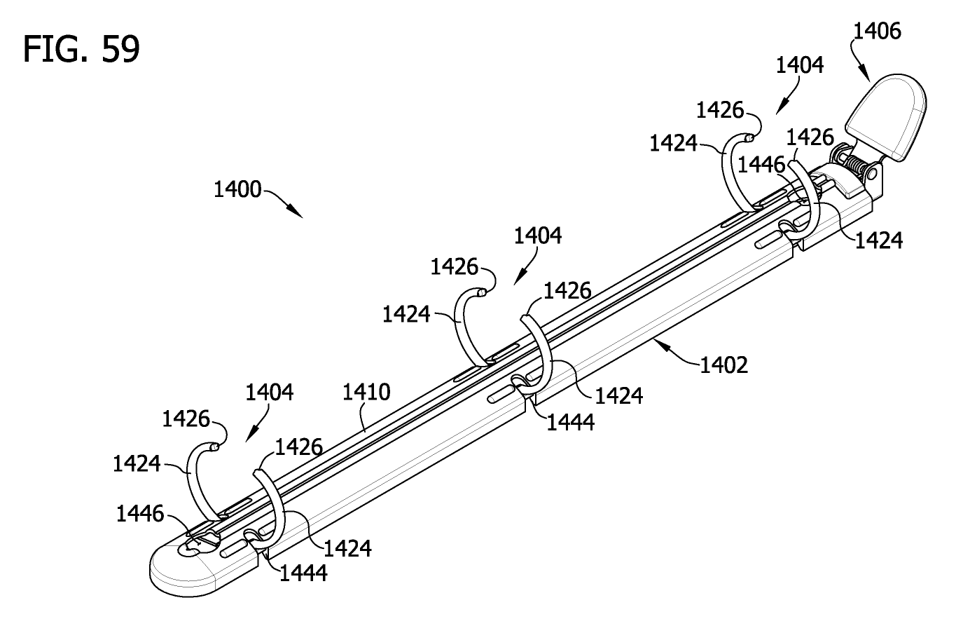

A fourteenth embodiment of a ring binder mechanism 1400 with a plastic upper housing element 1410 is illustrated in FIGS. 51-59. The fourteenth embodiment is generally similar to the tenth embodiment, but it incorporates features disclosed in the twelfth and thirteenth embodiments as well. Overall operation of the fourteenth embodiment is generally the same as operation of the tenth embodiment.

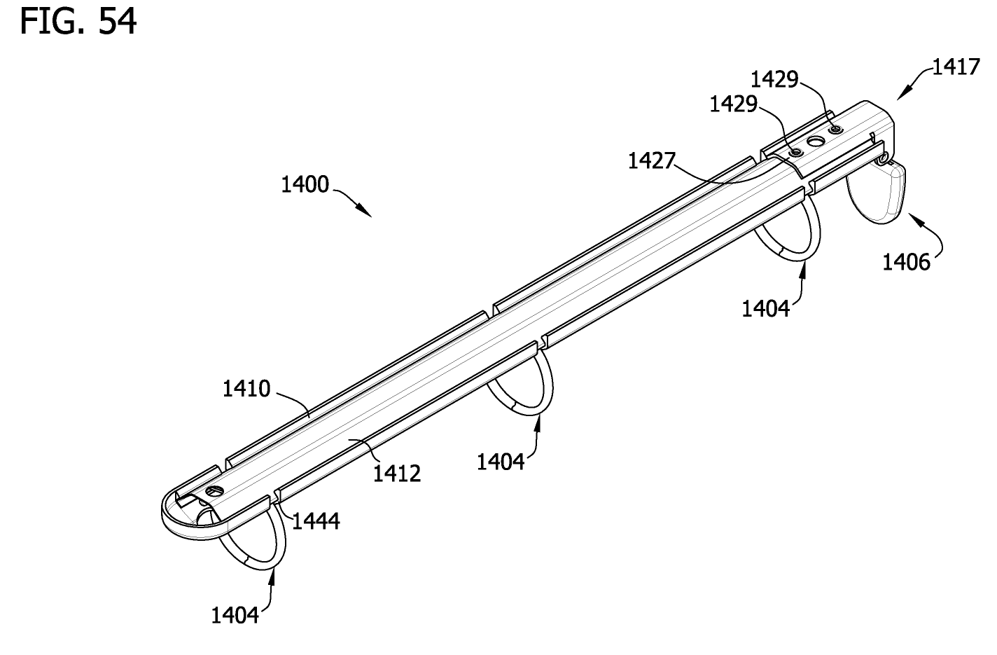

In particular, the lower housing element of the ring binder mechanism 1400 is identical to that in the ring binder mechanism 1200 in that the housing end extension portion 1417 is provided by means of a separate extension piece 1427, which is attached to the underside of the lower housing element 1412, e.g., by means of rivets 1429 as shown in FIG. 54. Similarly, the hinge plates 1428 are identical to the hinge plates 1328 of the thirteenth embodiment.

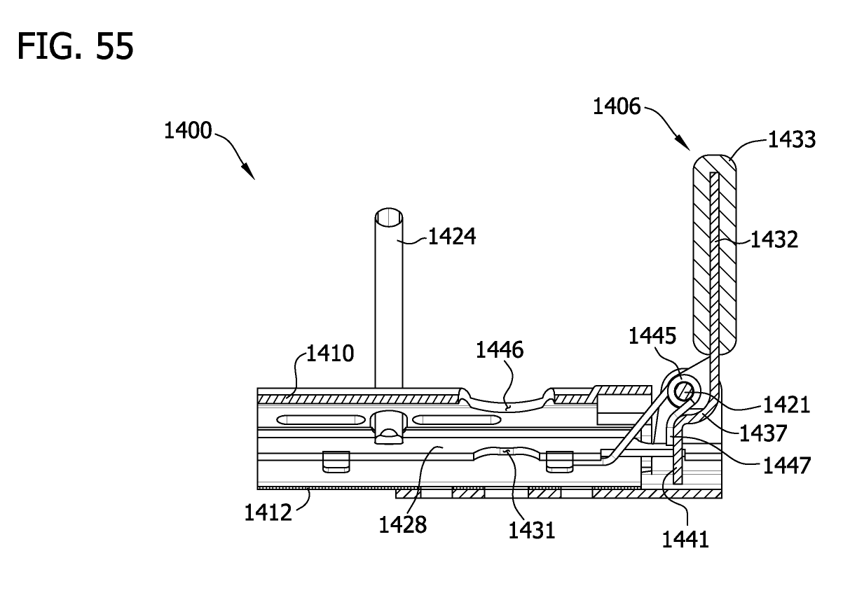

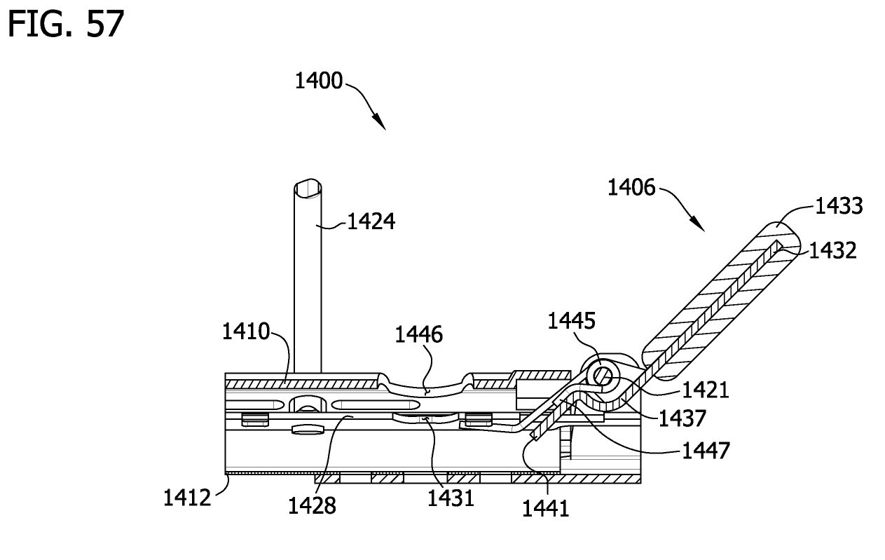

The configuration of the lever 1406, on the other hand, is different from (although somewhat similar to) the levers 1006, 1106, 1206, and 1306 in the tenth, eleventh, twelfth, and thirteenth embodiments 1000, 1100, 1200, and 1300, respectively. As best shown in FIGS. 55 and 57, the lever 1406, which may conveniently be formed from a bent piece of material such as metal, includes an upstanding grip 1432. The grip 1432 may include a plastic or rubber grip cover 1433 to improve comfort, as shown, if so desired. A longitudinal jog-out portion 1437 (longitudinal with respect to the overall lengthwise orientation of the ring binder mechanism 1400) is formed at the base of the grip 1432, and a tab 1441 depends from the forward end jog-out portion 1437. A notch 1443 is formed in either side of the tab 1441. Bent-forward ears 1405 are provided on either side of the lever 1406, just above the jog-out portion 1437, extending forward relative to the grip 1432, and a hole 1435 is formed in each ear 1405.

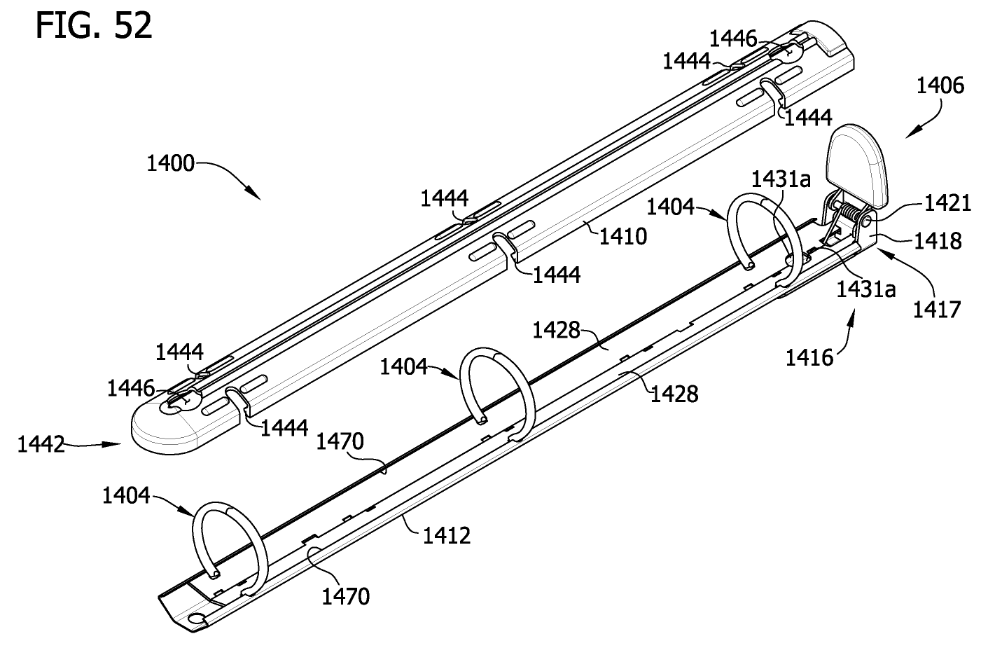

The lever 1406 is positioned at the longitudinal end 1416 of the lower housing element 1412—mounted to the extension piece 1427—between the wall elements 1418, as best shown in FIGS. 52, 53, and 59, with the holes 1435 in the ears 1405 aligned with the holes 1419 in the wall elements 1418. A pivot pin 1421 passes through the holes 1435 and 1419, in front of the grip 1432 and just above the jog-out portion 1437, to pivotally attach the lever 1406 to the lower housing element 1412. When the ring binder mechanism 1400 is assembled, the ends 1477 of the hinge plates 1428 fit within the notches 1443 in the sides of the tab 1441 depending from the lever jog-out portion, with the hinge plate tabs 1476 positioned behind the depending tab 1441. (This configuration prevents the lever 1406 from pivoting too far forward, i.e., in a direction away from the opening direction.)

As best shown in FIGS. 52, 53, 55, 57, and 59, a torsion spring 1445 is provided around the pivot pin 1421, between the bent-forward ears 1405. One end 1447 of the torsion spring 1445 bears against the front surface of the depending tab 1441, as best shown in FIGS. 55 and 57, and the other end 1449 of the torsion spring 1445 hooks under one of the hinge plates 1428 at a position slightly forward of the end 1477 of the hinge plates 1428, as best shown in FIGS. 52, 55, and 57. The torsion spring 1445 biases the lever 1406 toward the upright position, as shown in FIG. 55.

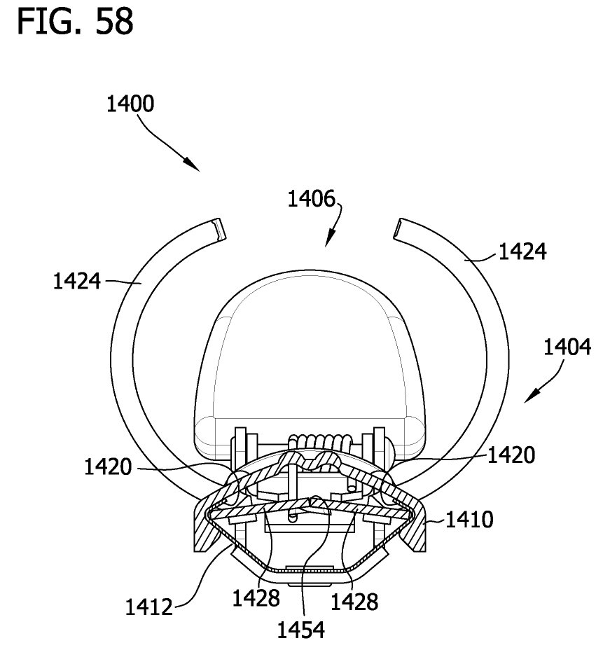

To open the ring binder mechanism 1400, the lever 1406 is pivoted outwardly, i.e., to the right as shown in FIGS. 55 and 57. As the lever 1406 pivots, bottom surfaces of the notches 1443 in the depending tab 1441 press against lower surfaces of the ends of the hinge plates 1428. Depending on the specific geometry of the hinge plates 1428, the end portions of the hinge plates may flex upward slightly relative to the majority of the length of the hinge plates before the hinge plates are driven through their co-planar position, thus allowing the lever 1406 to pivot outwardly by a slight amount before the rings 1404 actually open. If the lever 1406 is released before the hinge plates pass through their co-planar position, the hinge plates will relax and the torsion spring 1445 will return the lever 1406 to its upright position. Given sufficient continued pressure, however, the hinge plates 1428 will overcome the spring force generated by the lower housing element 1412 and pivot into their open position, as shown in FIGS. 57 and 58. In that position, the return torsional force generated by the torsion spring 1445 is insufficient to overcome the spring force of the lower housing element 1412, and the ring binder mechanism 1400 will remain in the open position.

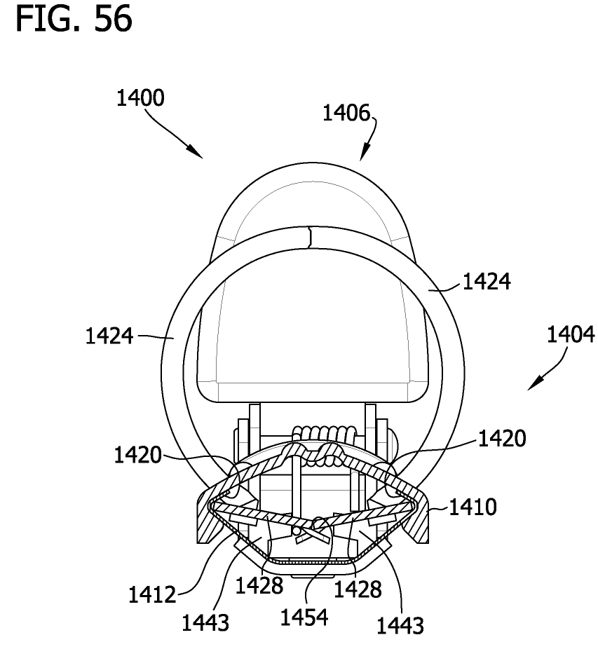

The ring binder mechanism 1400 may then be closed by pivoting the lever 1406 back toward the upright position, i.e., to the left as shown in FIGS. 55 and 57. As the lever 1406 pivots, upper surfaces of the notches 1443 in the depending tab 1441 press against upper surfaces of the ends of the hinge plates 1428 to drive the hinge plates 1428 back to their closed position, as shown in FIGS. 55 and 56.

The preceding embodiments of ring binder mechanisms all include one or more levers to assist with opening and closing the ring binder mechanism. It will be appreciated, however, that the inventive concept can be applied to ring binder mechanisms that do not include levers to open and close the ring binder mechanism. Some examples of such embodiments are described below.

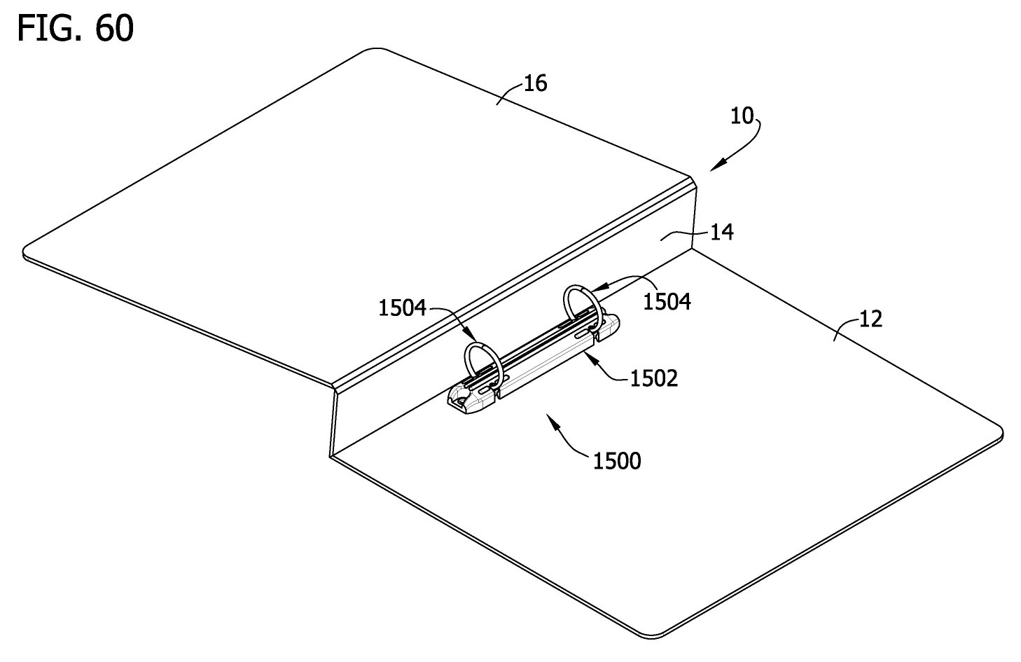

A fifteenth embodiment of a ring binder mechanism 1500 with a plastic upper housing element 1510 is illustrated in FIGS. 60-65. The ring binder mechanism 1500 includes components that are similar to those employed in the first embodiment of a ring binder mechanism 100, and corresponding components are labeled with reference numbers that have been incremented by 1400, i.e., in the 1500's.

In FIG. 60, the mechanism 1500 is shown mounted on a notebook designated generally at 10. Specifically, the mechanism 1500 is shown mounted on the back cover 12 of the notebook 10, generally adjacent to and aligned with the spine 14 of the notebook 10. The front cover 16 of the notebook 10 is hingedly connected to the spine 14 and moves to selectively cover or expose loose-leaf pages (not shown) retained by the mechanism 1500 in the notebook 10.

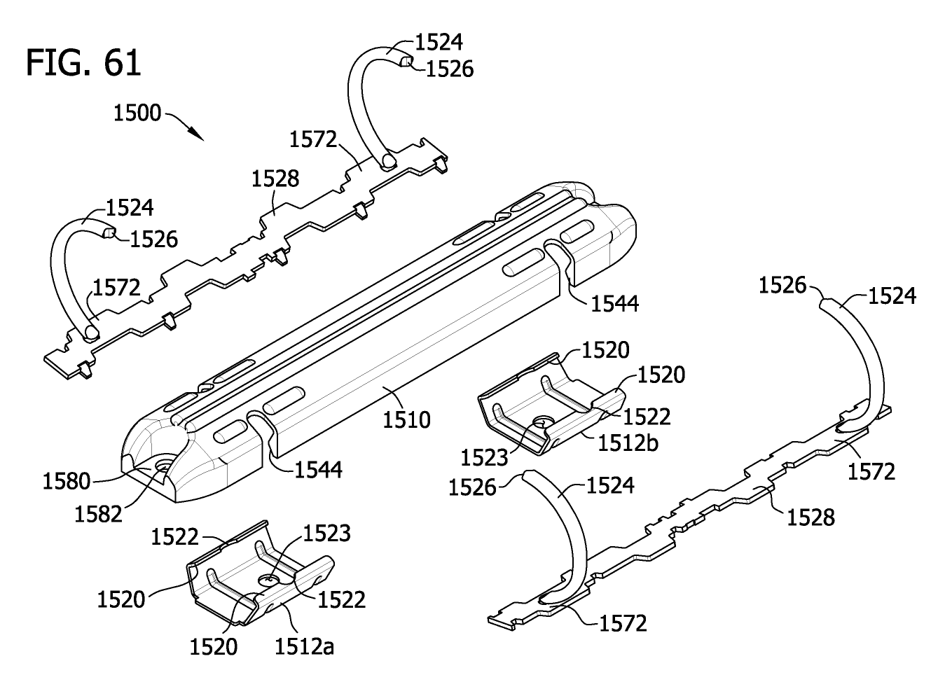

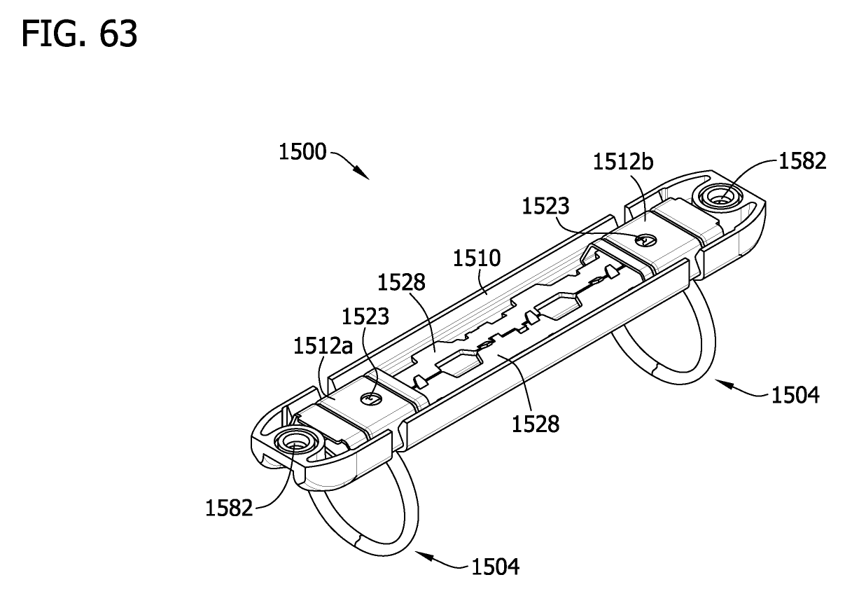

As is shown in FIGS. 61 and 63, the ring binder mechanism 1500 includes a lower housing element that is comprised of multiple pieces 1512a and 1512b. Suitably, there are the same number of lower housing element pieces as there are rings 1504, e.g., two (as illustrated), three, four, etc.

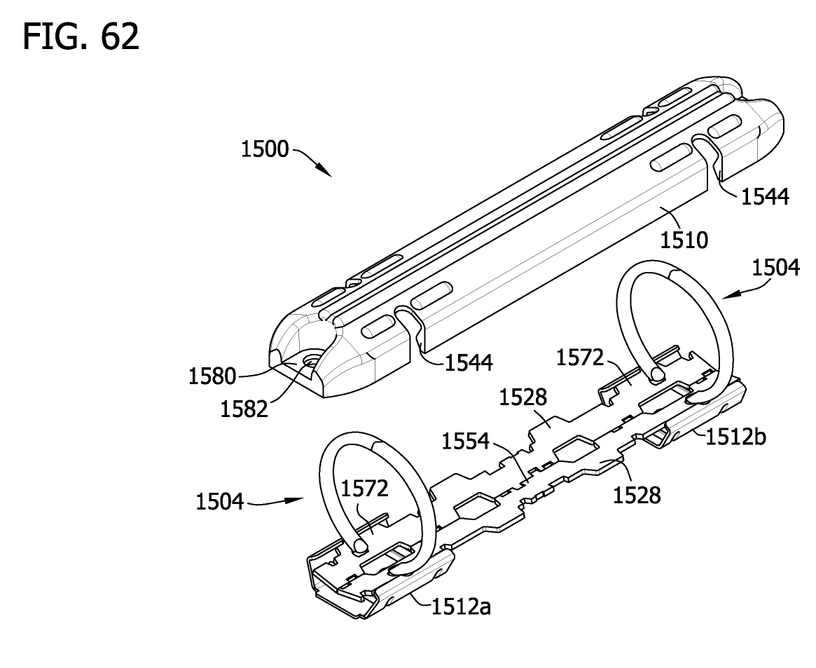

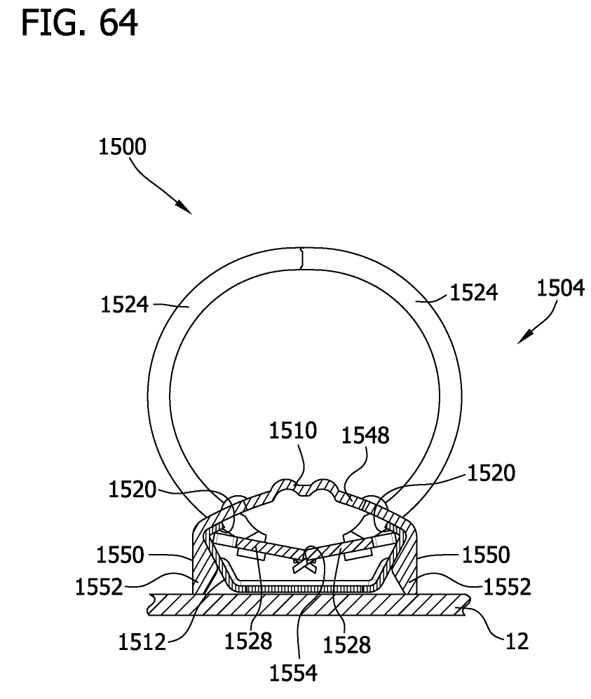

Additionally, the ring binder mechanism 1500 includes a pair of hinge plates 1528 (broadly, a “ring support”). The hinge plates 1528 are pseudo-skeletonized (i.e, reduced to a minimum amount of material) for much the same reasons of material cost savings and manufacturing efficiency associated with the skeletonized hinge plates described above. The skeletonized hinge plates 1528 are, however, slightly more angular in form than the skeletonized hinge plates described above, which are more sinusoidal or serpentine in shape. The hinge plates 1528 are supported by the lower housing element pieces 1512a, 1512b, with the outer edges of peaks 1572 disposed just under bent-in rims 1520, as best shown in FIG. 64. Notches 1522 are provided in the bent-in rims to accommodate the ring members 1524, as best shown in FIG. 62.

As shown in FIG. 64, the upper housing element 1510 includes a central portion 1548 and lateral sides 1550 extending downwardly along either side of the central portion 1548. The lateral sides 1550 are spaced apart by a distance that is essentially the same as the width of the lower housing element pieces 1512a, 1512b, but ridges 1552 protrude slightly inwardly. This configuration allows the upper housing element 1510 to be snap-fit connected to the lower housing element pieces 1512a, 1512b. Slots 1544 are provided in the sides of the upper housing element 1510 to accommodate the rings 1504.

As further illustrated in FIG. 64, the upper housing element 1510 is configured to cover the lower housing element pieces 1512a, 1512b completely, with lower edges of the upper housing element 1510 contacting the surface on which the ring binder mechanism 1500 is mounted. The longitudinal ends of the upper housing element 1510 includes flats 1580, and mounting holes 1582 extend through the flats 1580 to facilitate mounting the ring binder mechanism 1500 to the surface on which it is mounted. (Additionally or alternatively, the ring binder mechanism could be mounted via holes 1523 in the bottoms of the lower housing element pieces 1512a, 1512b.)

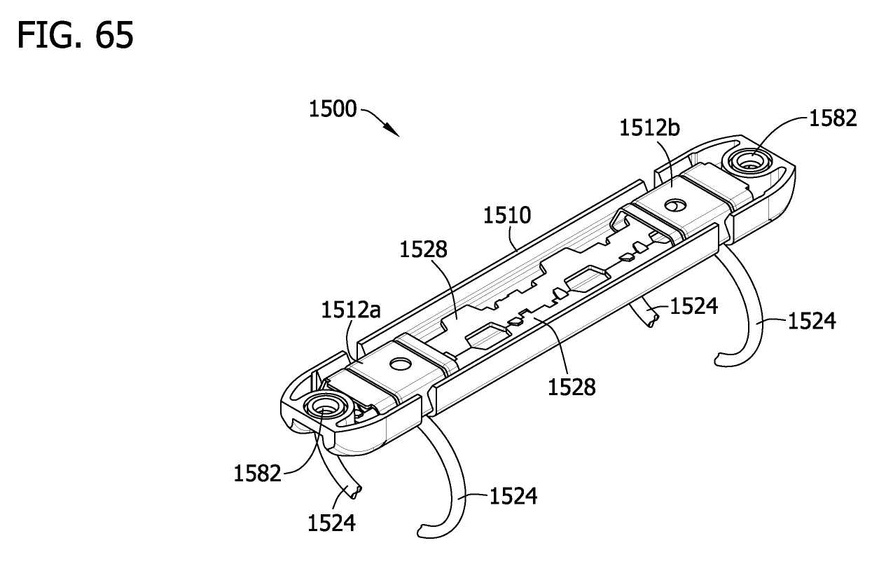

As in the above-described embodiments, the hinge plates 1528 abut along inner longitudinal edges in interleaved fashion to form a central hinge 1554, as is known in the art. The hinge plates 1528 pivot upward and downward relative to the lower housing element pieces 1512a, 1512b about the central hinge 1554, and move the ring members 1524 mounted thereon between a closed position (e.g., FIGS. 63 and 64) and an open position (e.g., FIG. 65). The hinge plates 1528 are wider than the lower housing element pieces 1512a, 1512b when in a co-planar position (180°), so as they pivot through the co-planar position, they deform the lower housing element pieces 1512a, 1512b, which creates a small spring force in the lower housing element pieces. The spring force biases the hinge plates 1528 to pivot away from the co-planar position, either downward or upward. The ring members 1524 close when the hinge plates 1528 pivot downward (i.e., the hinge 1554 moves toward the lower housing element pieces 1512a, 1512b, as shown in FIG. 64); the ring members 1524 open when the hinge plates 1528 pivot upward (i.e., the hinge 1554 moves away from the lower housing element pieces 1512a, 1512b.

Operation of the ring binder mechanism 1500 is straightforward. To open the mechanism, the ring members 1524 of one of the rings 1504 are manually pulled apart with sufficient force to overcome the spring force of the lower housing element pieces 1512a, 1512b, which causes the hinge plates 1528 to pivot upwardly and open the rings 1504. To close the mechanism, the ring members 1524 of one of the rings 1504 are pushed together with sufficient force to overcome the spring force of the lower housing element pieces 1512a, 1512b, which causes the hinge plates 1528 to pivot downwardly and close the rings 1504.

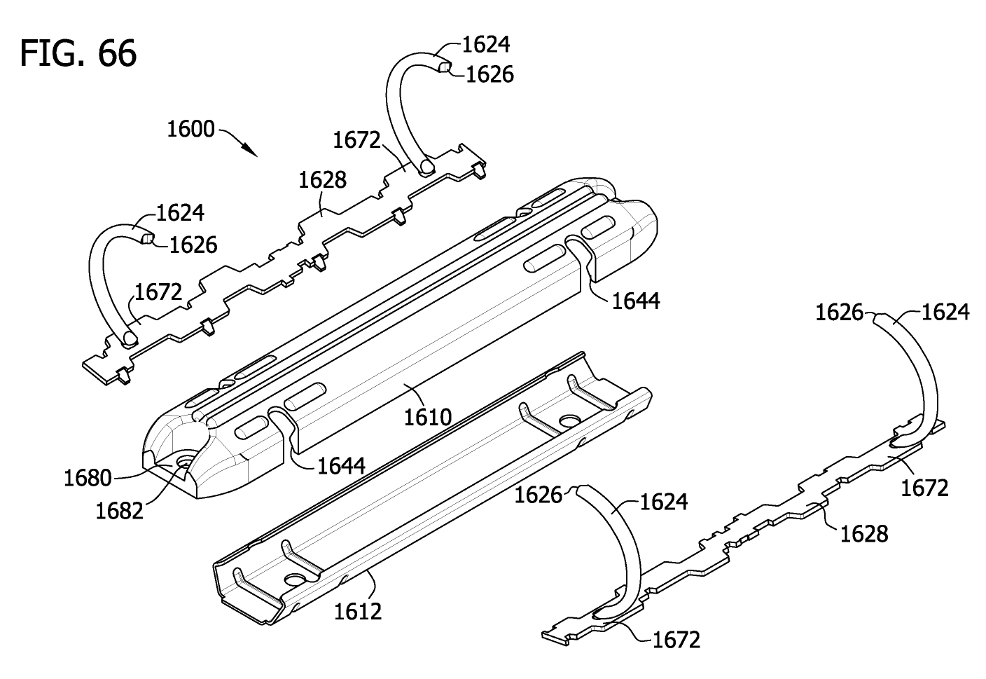

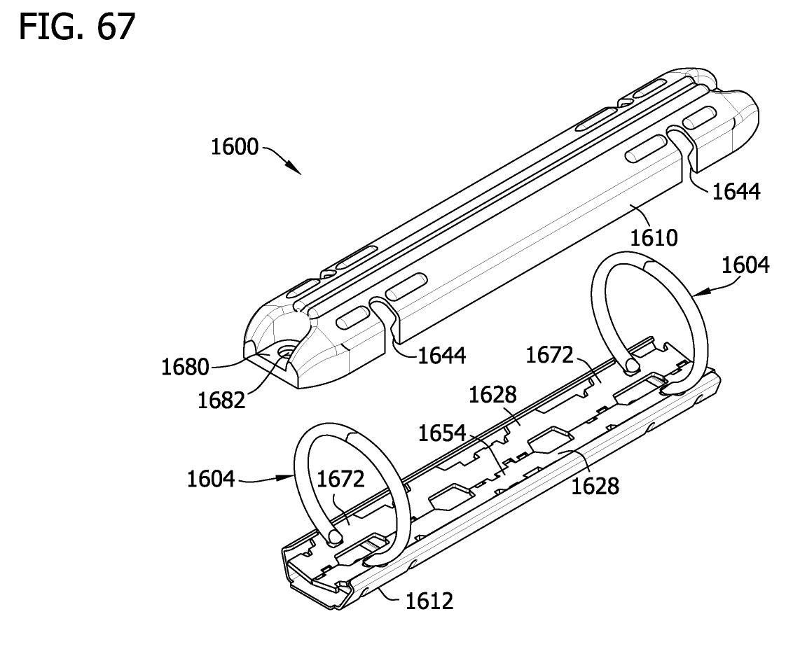

A sixteenth embodiment of a ring binder mechanism 1600 with a plastic upper housing element 1610 according to the invention is illustrated in FIGS. 66 and 67. The sixteenth embodiment is substantially identical to the fifteenth embodiment, and corresponding components are labeled with reference numbers that have been incremented by 100, i.e., that are in the 1500's. Operation of the two mechanisms 1500 and 1600 is identical. The difference between the fifteenth and sixteenth embodiments is that in the sixteenth embodiment, the lower housing element 1612 is constituted by a single elongated member that is approximately the same length as, but slightly shorter than, the upper housing element 1610, rather than separate lower housing element pieces.

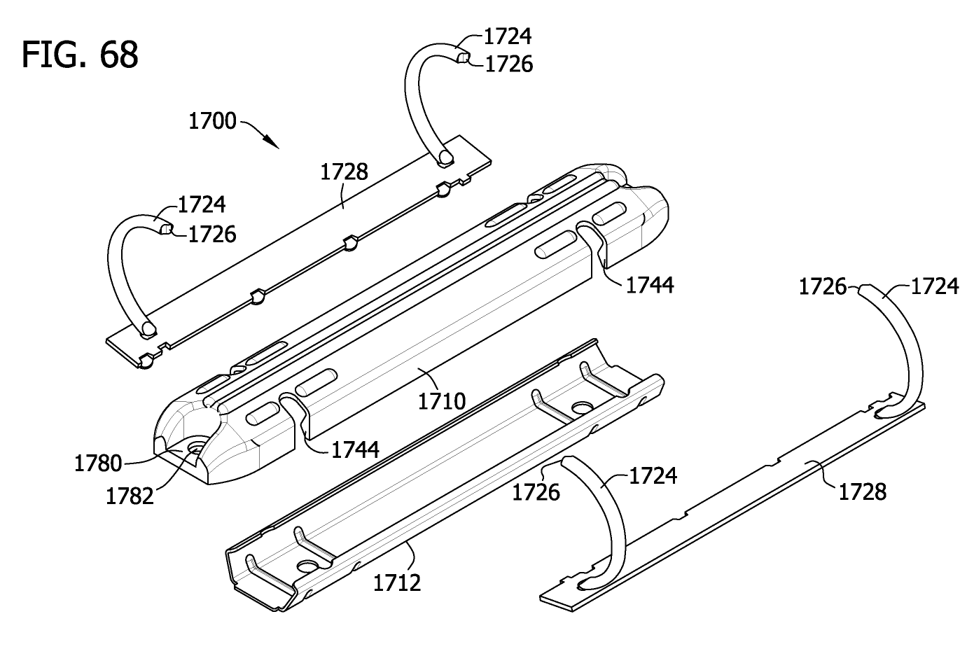

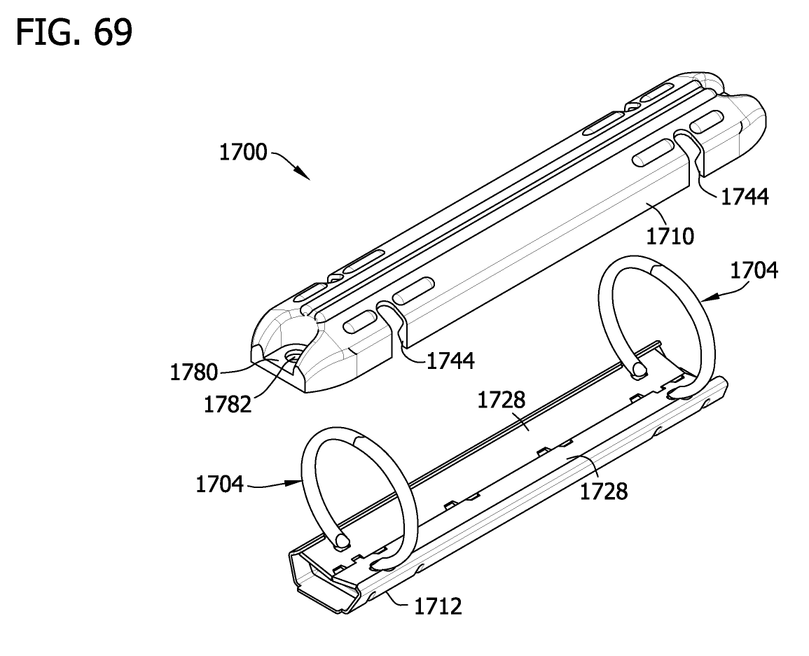

FIGS. 68 and 69 illustrate a seventeenth embodiment of a ring binder mechanism with a plastic upper housing element 1710. This ring binder mechanism 1700 is substantially identical to that of the sixteenth embodiment, and corresponding components are labeled with reference numbers that have been incremented by 100, i.e., that are in the 1600's. Operation of the two ring binder mechanisms 1600 and 1700 is identical, with the only difference being that the hinge plates 1728 of this seventeenth embodiment are formed as generally rectangular plates, rather than as pseudo-skeletonized members.

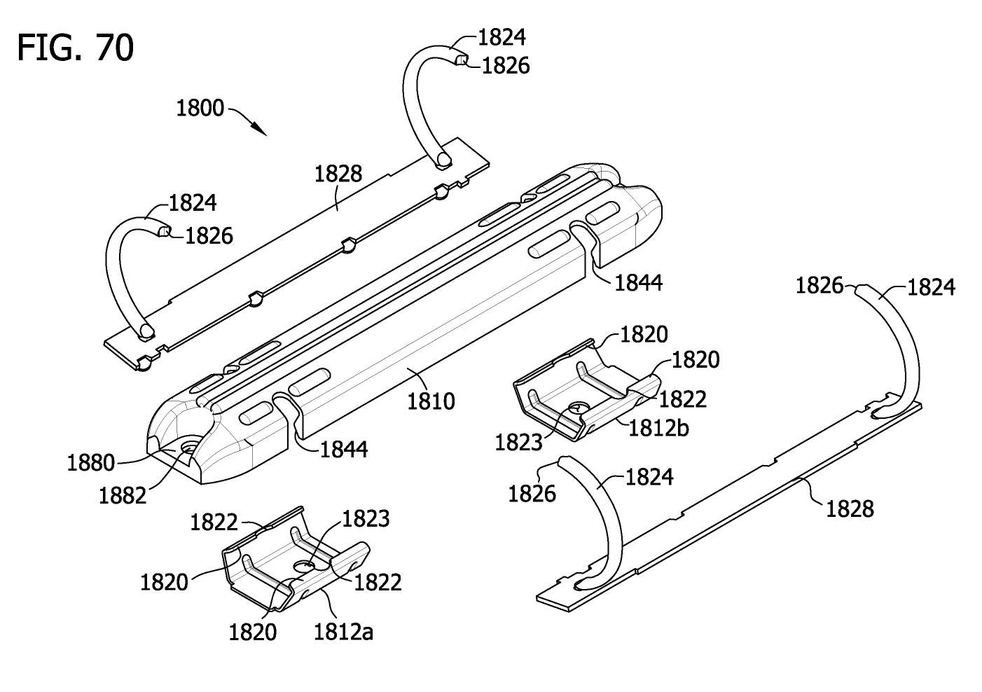

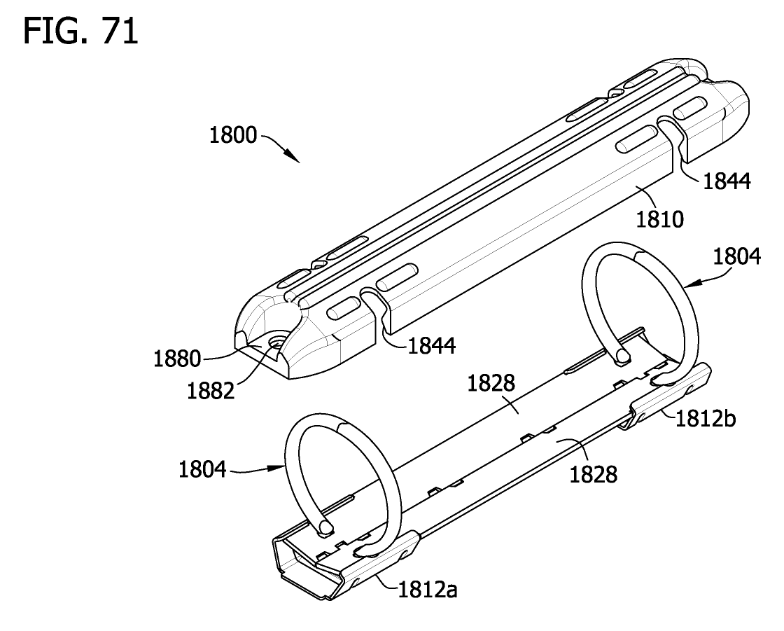

An eighteenth embodiment of a ring binder mechanism 1800 with a plastic upper housing element 1810 is illustrated in FIGS. 70 and 71. This eighteenth embodiment is substantially identical to the seventeenth embodiment, and corresponding components are labeled with reference numbers that have been incremented by 100, i.e., that are in the 1800's. Operation of the ring binder mechanisms 1700 and 1800 is identical. The difference between the seventeenth and eighteenth embodiments is that in this eighteenth embodiment, the lower housing element is constituted by multiple lower housing element pieces 1812a, 1812b (as in the ring mechanism 1500 of the fifteenth embodiment), rather than a single elongated member.

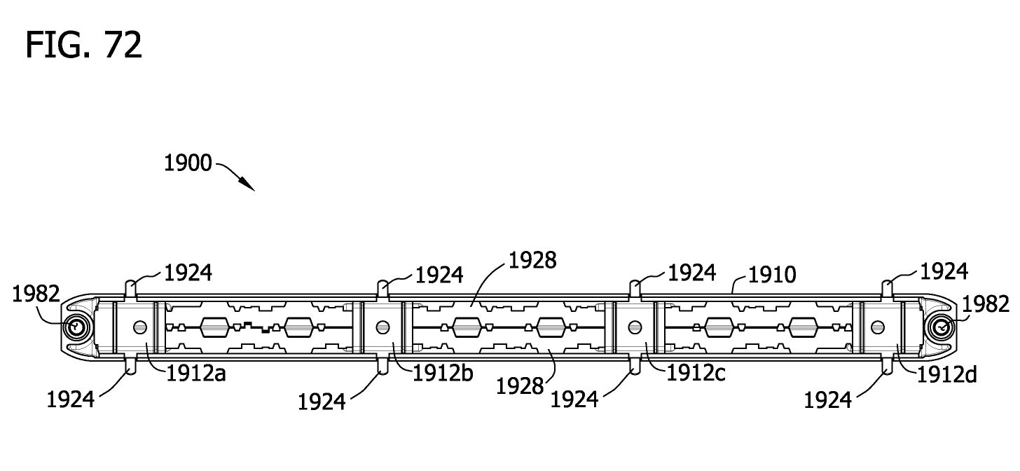

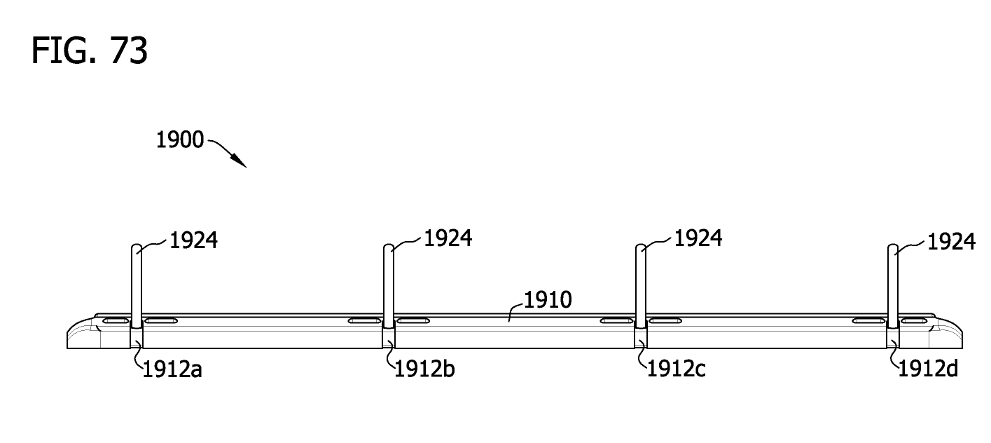

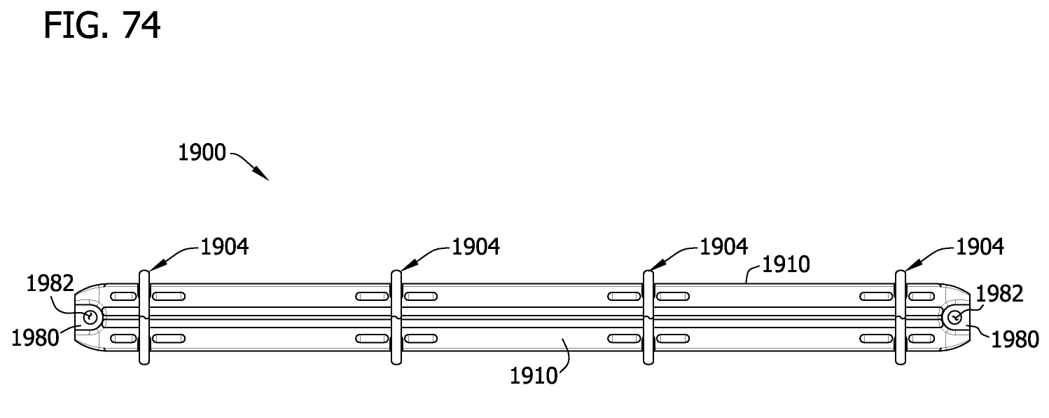

A nineteenth embodiment of a ring binder mechanism 1900 with a plastic upper housing element 1910 is illustrated in FIGS. 72, 73, and 74. The nineteenth embodiment is substantially the same as the fifteenth embodiment, and corresponding components are labeled with reference numbers that have been incremented by 400, i.e., that are in the 1900's. Operation of the ring binder mechanisms 1500 and 1900 is identical. The only difference between these mechanisms 1500, 1900 is that the ring binder mechanism 1900 is longer than the ring binder mechanism 1500 and includes four rings 1904 instead of two. Additionally, the ring binder mechanism 1900 includes four lower housing element pieces 1912a, 1912b, 1912c, and 1912d—again the same number as the number of rings 1904—rather than two.

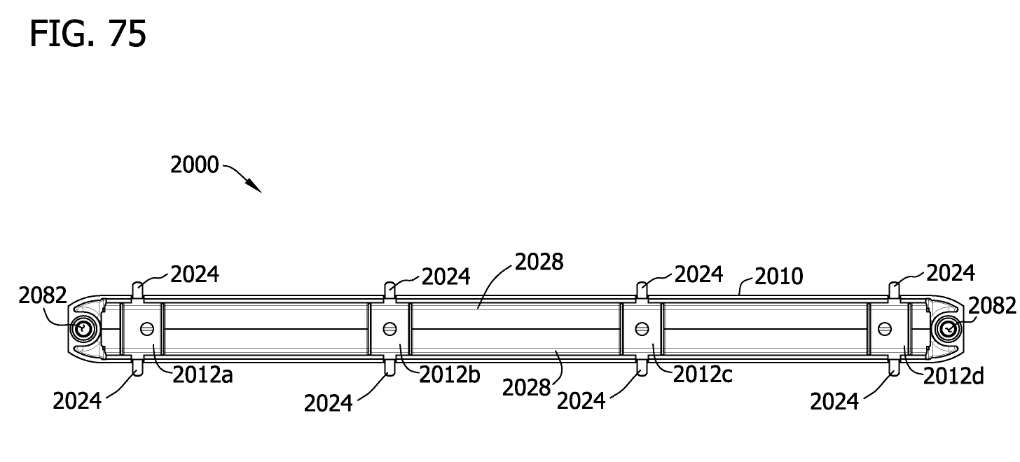

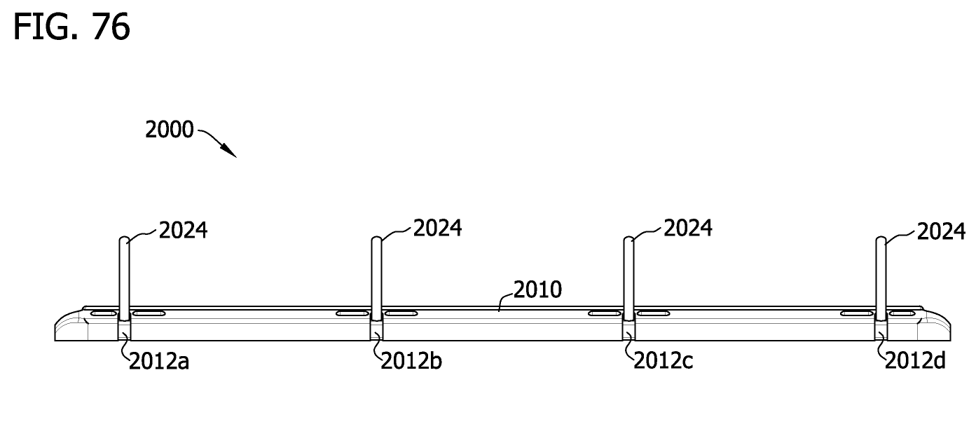

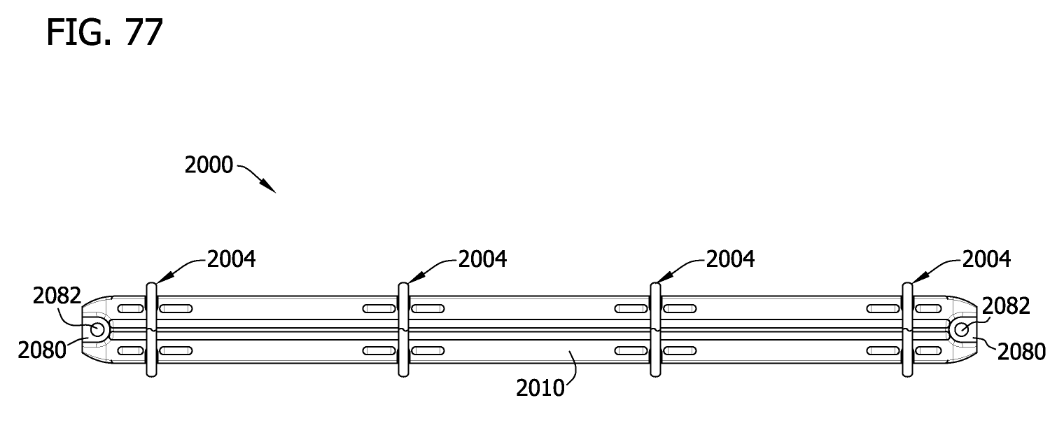

A twentieth embodiment 2000 of a ring binder mechanism with a plastic upper housing element 2010 according to the invention is illustrated in FIGS. 75, 76, and 77. The twentieth embodiment 2000 is substantially identical to the nineteenth embodiment 1900, and corresponding components are labeled with reference numbers that have been incremented by 100, i.e., that are in the 2000's. Operation of the two mechanisms 1900 and 2000 is identical, with the only difference being that the hinge plates 2028 are formed as generally rectangular plates, rather than as pseudo-skeletonized members.

When introducing elements of the ring binder mechanisms herein, the articles “a”, “an”, “the” and “said” are intended to mean that there are one or more of the elements. The terms “comprising”, “including” and “having” and variations thereof are intended to be inclusive and mean that there may be additional elements other than the listed elements. Moreover, the use of “forward” and “rearward” and variations of these terms, or the use of other directional and orientation terms, is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A ring binder mechanism for holding loose-leaf pages, the mechanism comprising:
an elongate housing including an upper, plastic housing element and a lower housing element underlying the upper housing element;
a ring support disposed between the upper and lower housing elements and supported by the housing for movement relative to the housing; and
rings for holding the loose-leaf pages, each ring including a first ring member and a second ring member, the first ring member being mounted on the ring support for movement relative to the second ring member between a closed position and an opened position, in the closed position the two ring members form a substantially continuous, closed loop for allowing loose-leaf pages retained by the rings to be moved along the rings from one ring member to the other, and in the opened position the two ring members form a discontinuous, open loop for adding or removing loose-leaf pages from the rings.

2. The ring binder mechanism as set forth in claim 1 further comprising a spring adapted to bias the ring support toward the opened and closed positions of the ring members.

3. The ring binder mechanism as set forth in claim 2 wherein the lower housing element comprises the spring.

4. The ring binder mechanism as set forth in claim 1 wherein the lower housing element is formed from one-piece.

5. The ring binder mechanism as set forth in claim 2 wherein the lower housing element has a length that is substantially equal to a length of the upper housing element.

6. The ring binder mechanism as set forth in claim 1 wherein the lower housing element is formed from multiple pieces.

7. The ring binder mechanism as set forth in claim 6 wherein the number of pieces forming the lower housing element is the same as the number of rings.

8. The ring binder mechanism as set forth in claim 7 wherein the number of rings is selected from a group consisting of two, three, and four.

9. The ring binder mechanism as set forth in claim 6 wherein the pieces of the lower housing element are longitudinally spaced from each other along the length of the upper housing element.

10. The ring binder mechanism as set forth in claim 9 wherein each of the pieces forming the lower housing element is longitudinally aligned with a corresponding ring.

11. The ring binder mechanism as set forth in claim 1 wherein the lower housing element is formed from metal.

12. The ring binder mechanism as set forth in claim 1 further comprising an actuator mounted on the housing for movement relative to the housing for causing the movement of the ring support.

13. The ring binder mechanism as set forth in claim 12 wherein the actuator is mounted on the lower housing.

14. The ring binder mechanism as set forth in claim 1 further comprising two actuators mounted on the lower housing element adjacent opposing ends thereof, the actuators being capable of movement relative to the housing for causing the movement of the ring support.

15. The ring binder mechanism as set forth in claim 14 wherein the actuators are levers.

16. The ring binder mechanism as set forth in claim 1 wherein the lower housing element comprises a plurality of tabs spaced along the longitudinal length thereof.

17. The ring binder mechanism as set forth in claim 1 wherein the ring support comprises a pair of hinge plates.

18. The ring binder mechanism as set forth in claim 17 wherein the hinge plates are skeletonized.

19. The ring binder mechanism as set forth in claim 1 wherein the upper housing element has a snap-fit connection with the lower housing element.

20. The ring binder mechanism as set forth in claim 1 in combination with a cover, the ring binder mechanism being mounted on the cover, the cover being hinged for movement to selectively cover and expose loose-leaf pages when retained on the ring binder mechanism.
